(19) United States
(12) Patent Application Publication
(10) Pub. No.: US 2020/0087057 A1
(43) Pub. Date: Mar. 19, 2020

(54) BIODEGRADABLE COFFEE FILTER SYSTEM

(71) Applicant: Brett C. Richardson, Clive, IA (US)

(72) Inventor: Brett C. Richardson, Clive, IA (US)

(21) Appl. No.: 16/567,530

(22) Filed: Sep. 11, 2019

Related U.S. Application Data
(60) Provisional application No. 62/730,833, filed on Sep. 13, 2018.

(51) Int. Cl. B65D 85/804; B65D 65/46; A47J 31/36

(52) U.S. Cl. CPC B65D 85/8046; A47J 31/3628; B65D 65/466

(57) ABSTRACT

A biodegradable coffee filter system, method of use, and packaging are presented that provide an environmentally friendly means of brewing single-serve cups as well as a method of using the system and a means for transporting and/or shipping a plurality of the pods. The pod is formed of a filter material with a top, a bottom, and a lip. The top and the bottom are fitted together in a way that forms a hollow interior that houses a brewing medium. The top and bottom are fitted together at a lip which facilitates holding the pod in place throughout the brewing process. A method of using the pod is presented whereby the pod is placed within a reusable holder, and the pod is held in place by a lip.

### CROSS REFERENCE TO RELATED APPLICATIONS

This application claims priority to U.S. Provisional Application No. 62/730,833 which was filed on Sep. 13, 2019, the entirety of which is incorporated herein fully by reference.

### FIELD OF THE DISCLOSURE

This present disclosure relates to a biodegradable, disposable, single-use and single serving beverage package, method of use, and containment device for holding a plurality of pods.

### BACKGROUND OF THE DISCLOSURE

Coffee makers, tea brewers, k-cups, and other single cup brewing devices are old and well known in the art. Coffee makers, such as a Keurig or Nespresso machine, provide single serve cups of beverages for offices, homes, and other establishments. Typically, single serve beverage options come in a large variety of coffee types, tea flavors, and other brewed beverage options. A user inserts a single packet, k-cup, or pod into a brewing machine, and within minutes enjoys a freshly brewed cup of their chosen beverage. After use, the packet, k-cup, or pod is thrown away.

K-cups, presently the most popular form of single-serve brewing pods have fundamentally changed the way people enjoy their beverage of choice in recent years. 1 in 3 American homes now has a pod-based coffee machine. In 2014, enough k-cups were sold that if placed end-to-end, they would circle the globe 10.5 times. Almost every k-cup ends up in a landfill. K-cups are not recyclable. Keurig, just one of many companies selling K-cups, sold 9.8 billion Keurig brewed portion packs in 2014 alone.

The cups are made from #7 plastic. This plastic is recyclable, if clean, in only a few cities globally. This means that the use of k-cups have led to the generation of a tremendous amount of waste.

One presently available option is a reusable k-cup, or holder. These screened devices allow a user to place coffee grounds in a reusable cup which fits inside a typical Keurig machine. After the cup is brewed, a mess is left for the user to clean out the reusable cup, throw away the coffee grounds, usually into a disposal or an attempt to place in the trash. The cup must be cleaned before it can be used again. As such, using a reusable k-cup holder is substantially inconvenient, messy and time consuming. Which may explain why this option was popular when it was initially released, but sales have since plummeted as users have stuck with the more convenient disposable plastic option.

Making the waste problem worse, k-cups are shipped in individual cardboard boxes. These individual cardboard boxes, are shipped inside of larger cardboard boxes. These boxes contribute to the waste problem.

A better and less waste producing option is needed to fill the desire for convenient, single serve cups of coffee.

Therefore, for all the reasons stated above, and the reasons stated below, there is a need in the art for an environmentally friendly single serve beverage pod and means of shipping from producer to user that improves upon the state of the art.

Another object of the disclosure is to provide a single serve beverage pod system and method that is low waste and environmentally friendly.

Another object of the disclosure is to provide a single serve beverage pod system and method that is easy to use.

Yet another object of the disclosure is to provide a single serve beverage pod system and method that is easier to use than other single serve options available in the art.

Another object of the disclosure is to provide a single serve beverage pod system and method that is cleaner than other options available in the art.

Yet another object of the disclosure is to provide a single serve beverage pod system and method that is compatible with single-serve machines in residences, offices, and other establishments today.

Another object of the disclosure is to provide a single serve beverage pod system and method that is biodegradable.

Yet another object of the disclosure is to provide a single serve beverage pod system and method that holds its form during use.

Another object of the disclosure is to provide a single serve beverage pod system and method that store in an ambient environment.

Yet another object of the disclosure is to provide a single serve beverage pod system and method that is strong and stable.

Another object of the disclosure is to provide a single serve beverage pod system and method that is easy to place in a compatible brewing machine.

Yet another object of the disclosure is to provide a single serve beverage pod system and method that is easy to remove from a compatible brewing machine after use.

Another object of the disclosure is to provide a single serve beverage pod system and method that is a convenient way of brewing a single cup of a beverage.

Yet another object of the disclosure is to provide a single serve beverage pod system and method that improves on the efficiencies of the single serve pods in the art.

Another object of the disclosure is to provide a single serve beverage pod system and method that is safe.

These and other objects, features, or advantages of the disclosure will become apparent from the specification, figures and claims.

### BRIEF DESCRIPTION OF THE DRAWINGS

FIG. 1. is a perspective view of a biodegradable coffee filter system having a brewing machine for use with a biodegradable pod;

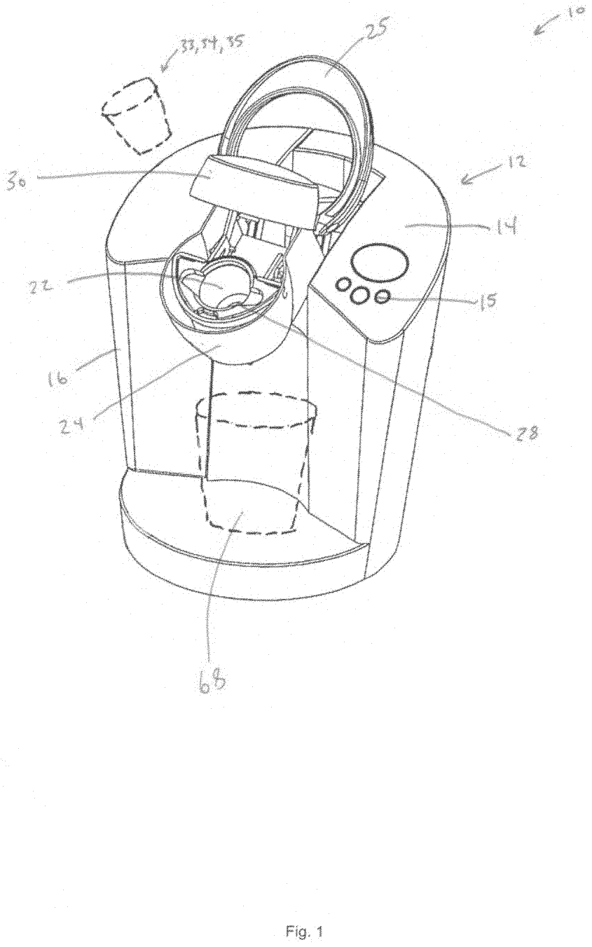

FIG. 2 is an exploded perspective view of a biodegradable coffee filter system having a brewing machine for use with a biodegradable pod;

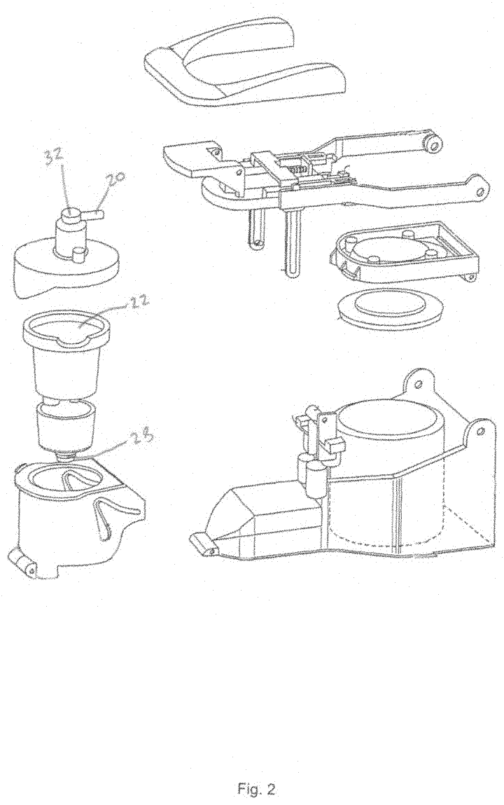

FIG. 3 is a perspective view of a biodegradable pod formed of a filter paper that holds brewing medium, the pod having an upper member and a lower member that forms a bottom wall, a sidewall and a lip, wherein the lip is formed of the upper member and the lower member being joined together in overlapping condition and sealed to one another; the view showing the biodegradable pod formed in a k-cup style pod;

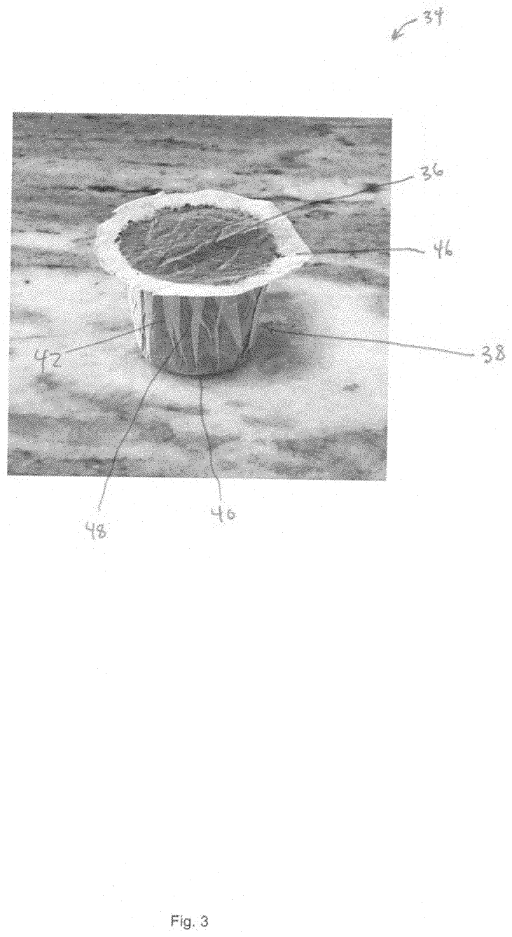

FIG. 4 is another perspective view of a biodegradable pod formed of a filter paper that holds brewing medium, the pod having an upper member and a lower member that forms a bottom wall, a sidewall and a lip, wherein the lip is formed of the upper member and the lower member being joined together in overlapping condition and sealed to one another; the view showing the biodegradable pod formed in a k-cup style pod;

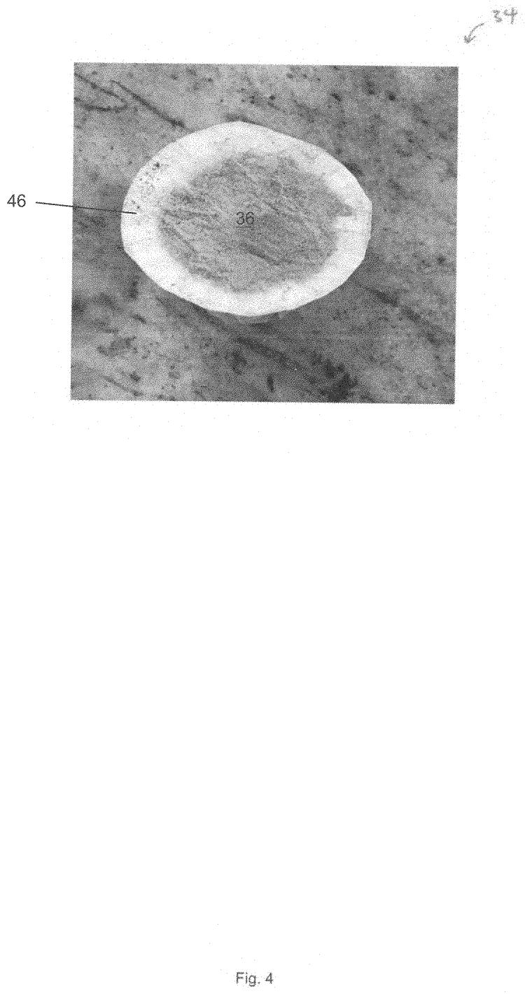

FIG. 5 is a perspective view of a pair of holders that are configured to hold a biodegradable pod formed of a filter paper that holds brewing medium, the view showing one of the holders having its upper member open, whereas the other holder has its upper member closed;

FIG. 6 is a perspective view of another embodiment of a biodegradable pod formed of a filter paper that holds brewing medium, the pod having an upper member and a lower member that forms a bottom wall, a sidewall and a lip, wherein the lip is formed of the upper member and the lower member being joined together in overlapping condition and sealed to one another; the view showing the biodegradable pod formed in to fit an Nespresso style brewing machine; the view also showing a holder having an upper member having a center cut out and side cut outs to allow needles to pass there through to enter the pod and a lower member that receives the pod and upper member;

FIG. 7 is another perspective view of another embodiment of a biodegradable pod formed of a filter paper that holds brewing medium, the pod having an upper member and a lower member that forms a bottom wall, a sidewall and a lip, wherein the lip is formed of the upper member and the lower member being joined together in overlapping condition and sealed to one another; the view showing the biodegradable pod formed in to fit an Nespresso style brewing machine; the view also showing a holder having an upper member having a center cut out and side cut outs to allow needles to pass there through to enter the pod and a lower member that receives the pod and upper member;

FIG. 8 is another perspective view of another embodiment of a biodegradable pod formed of a filter paper that holds brewing medium, the pod having an upper member and a lower member that forms a bottom wall, a sidewall and a lip, wherein the lip is formed of the upper member and the lower member being joined together in overlapping condition and sealed to one another; the view showing the biodegradable pod formed in to fit an Nespresso style brewing machine; the view also showing a holder having an upper member having a center cut out and side cut outs to allow needles to pass there through to enter the pod and a lower member that receives the pod and upper member;

FIG. 9 is a perspective view of three biodegradable pods formed of a filter paper that holds brewing medium, the pod having an upper member and a lower member that forms a bottom wall, a sidewall and a lip, wherein the lip is formed of the upper member and the lower member being joined together in overlapping condition and sealed to one another; the view showing the biodegradable pod formed in a k-cup style pod;

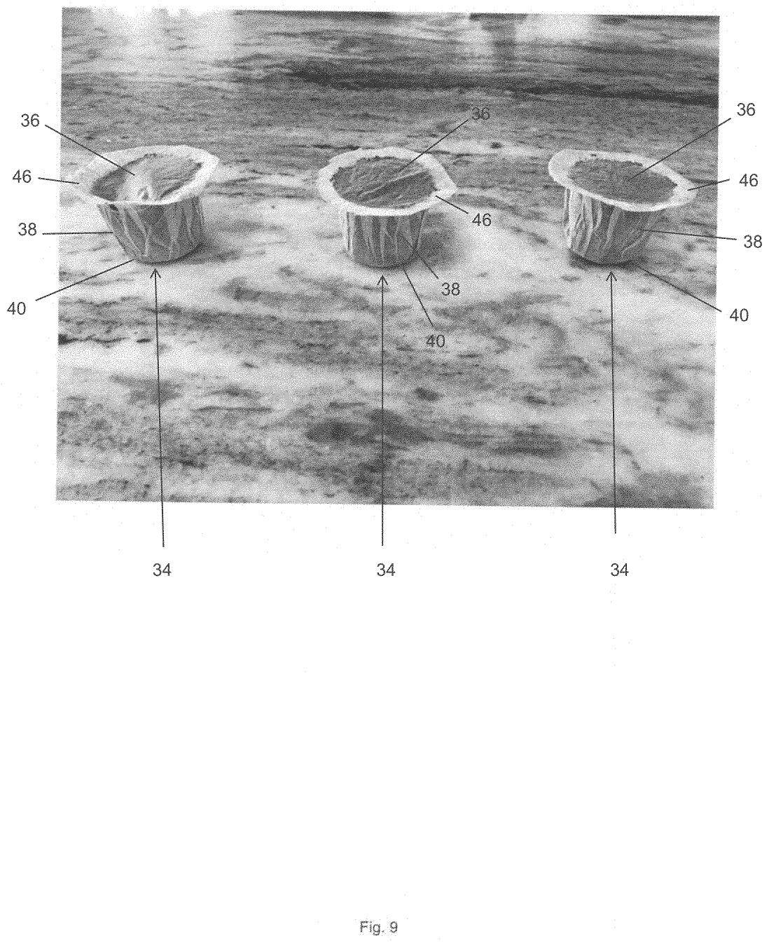

FIG. 10 is a perspective view of a low-waste bag that is configured to hold the biodegradable pods therein for transport;

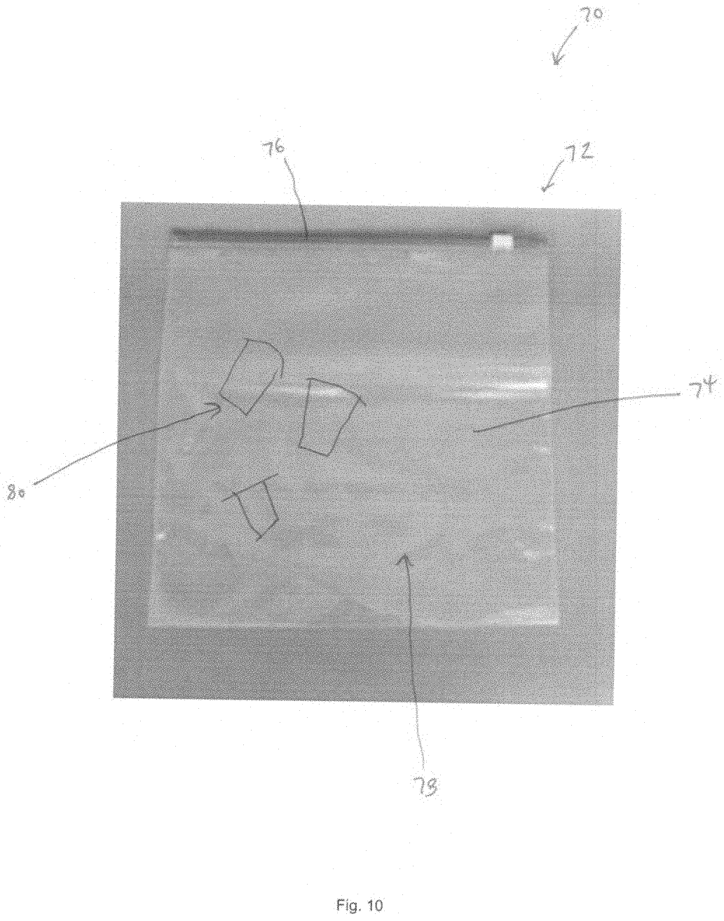

FIG. 11 is another perspective view of a low-waste bag that is configured to hold the biodegradable pods therein for transport;

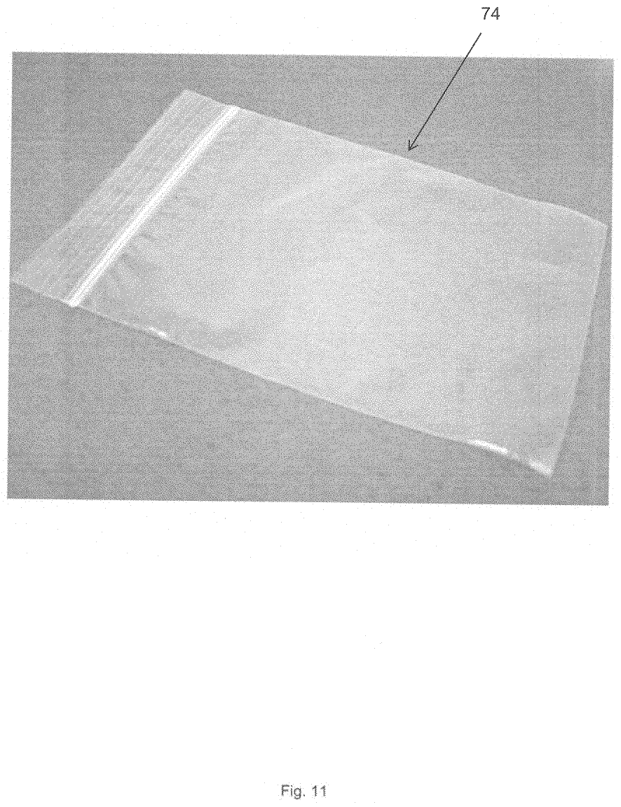

FIG. 12 is a side elevation section view of another embodiment of a biodegradable pod formed of a filter paper that holds brewing medium, the pod having an upper member and a lower member that forms a bottom wall, a sidewall and a lip, wherein the lip is formed of the upper member and the lower member being joined together in overlapping condition and sealed to one another; the view showing the biodegradable pod formed in a k-cup style pod; the pod having a rigid sidewall formed of a rigid biodegradable material; the sidewall also providing a gap between the bottom of the sidewall and the bottom wall so as to provide relief for an upwardly protruding needle.

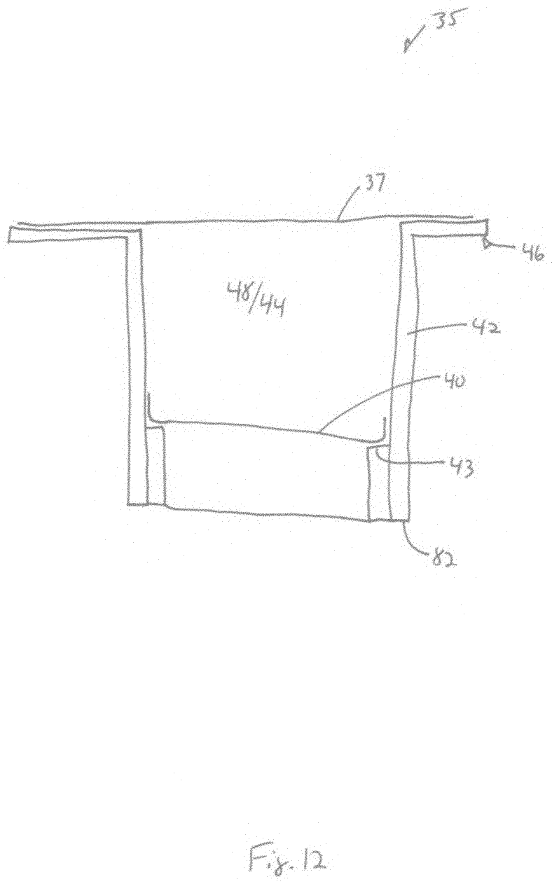

### SUMMARY OF THE DISCLOSURE

A biodegradable coffee filter system, method of use, and packaging are presented that provide an environmentally friendly means of brewing single-serve cups as well as a method of using the system and a means for transporting and/or shipping a plurality of the pods. In one arrangement, the biodegradable pod is formed to fit in a reusable k-cup. The pod is formed of a filter material with a top, a bottom, and a lip. The top and the bottom are fitted together in a way that forms a hollow interior that houses a brewing medium. The top and bottom are fitted together at a lip which facilitates holding the pod in place throughout the brewing process. A method of using the pod is presented whereby the pod is placed within a reusable holder, and the pod is held in place by a lip. The pod is disposed of after the brewing process is complete. A low-waste system for transporting the pod is also disclosed involving a re-sealable packaging which houses a plurality of pods while allowing the pods to maintain their form.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the disclosure.

System:

With reference to the figures, a biodegradable coffee filter system 10 (or simply system 10) is presented. The biodegradable coffee filter system 10 is formed of any suitable size, shape and design and is configured to facilitate brewing a single-serve portion of a beverage by a brewing machine 12 while producing little to no waste. In the arrangement shown, as one example, system 10 includes a brewing machine 12 having a main body 14, a water container 16, a heating system 18, a water delivery system 20, a receiver 22 having a lower member 24 which has a hollow interior 26 and a nipple 28, a cover member 30 having a nipple 32. In the arrangement shown, as one example, system 10 also includes a vessel 68.

In the arrangement shown, as one example, system 10 includes a brewing machine 12. Brewing machine 12 is formed of any suitable size, shape and design and is designed to facilitate with the brewing process of creating a single-serve beverage. In the arrangement shown, as one example, brewing machine 12 includes a main body 14 which is the general assembly of the brewing machine 12 and brings together the different components and/or parts and/or operations of the brewing machine 12 including the water container 16.

In the arrangement shown, as one example, brewing machine 12 includes a water container 16. Water container 16 stores and provides water to the brewing machine 12. Generally the water is heated before the brewing operation takes place. Brewing machine 12 includes a heating system 18 which heats water, generally, provided from a water container 16. Heating system 18, in the arrangement shown may be any heating system 18 of the various brewing machines 12 available on the market today. Brewing machine 12 also includes a water delivery system 20. The water delivery system 20 is formed of any suitable size, shape and design and is designed to deliver water to the pod 34 for the brewing process within the receiver 22.

In the arrangement shown, as one example, brewing machine 12 includes a receiver 22. Receiver 22 is formed of any suitable size, shape and design and is designed to receive and hold a pod 34 during the brewing process. In one arrangement, receiver 22 accepts a pod 34, the brewing process takes place and then receiver 22 ejects the pod 34 after the beverage is brewed. Receiver 22 has many forms but generally has a hollow interior 26 similar in shape to the brewing cup or device designed to be brewed by the brewing machine 12.

Receiver 22 is generally cylindrical in shape with an open top and sidewalls extending upward from a bottom wall of the receiver 22. The bottom wall of the receiver 22 is generally planar in shape with a nipple 28 designed to allow fluid to flow through the bottom of the receiver 22. Receiver 22 may be an elongated cylinder or may be a semi-spherical shape and/or any other shape hereby contemplated for use with receiving pods 34 for the brewing process. Receiver 22 is generally housed in the lower member 24 of a brewing machine but may be part of the brewing machine 12 in other means necessary to achieve the brewing process.

In the arrangement shown, brewing machine 12 also includes a lower member 24 and a cover member 30 which enclose the pod 34 during the brewing process. Lower member 24 and cover member 30 may be formed of any suitable size, shape and design and may be formed of a single member. Lower member 24 and cover member 30 are designed to close in on one another to receive a pod 34 for the brewing process; the cover member 30 closing down by a spring loaded mechanism while the lower member 24 closes up by a spring mechanism to meet the cover member 30. While the brewing machine 12 is one form a brewing machine 12 can take, other brewing machines 12 are hereby contemplated for use.

Additionally, in the arrangement shown, as one example, system 10 includes: a pod 34 having an upper member 36, a lower member 38 with a bottom wall 40, a sidewall 42, and a hollow interior 44. In the arrangement shown, as one example, pod 34 also includes a lip 46 and a medium 48. Pod 34 may be formed of any suitable size, shape and design and is designed to provide a single-serve brewing pod 34 which is environmentally friendly.

In the arrangement shown, as one example, system 10 includes a holder 50 having an upper member 52, a needle receiving member 53 of upper member 52, a lower member 54 with a bottom wall 56, a sidewall 58, a hollow interior 60, a screen member 62, and a needle receiving member 64 of lower member 54. In the arrangement shown, as one example, holder 50 also includes a hinge 66.

With reference to the figures, a low-waste system for transporting a plurality of pods 70 (system 70) is also presented. System 70 is configured to facilitate the transportation and/or movement and/or shipping of a plurality of pods 80 with minimal waste. In the arrangement shown, as one example, system 70 includes a bag 72, a sidewall 74 of the bag 72, a sealing member 76 of bag 72, a hollow interior 78 of bag 72, and a plurality of pods 80.

Pod:

In the arrangement shown, as one example, system 10 includes a pod 34 that is configured to facilitate the brewing of a medium 48 contained within a pod 34. Pod 34 is formed of any suitable size, shape and design and is configured to provide a single-serve portion of a desired brewing medium 48 to a consumer with minimal waste. Pod 34 is designed to fit within a variety of machines of many shapes and sizes and designed to be biodegradable.

In one arrangement shown, as one example, pod 34 is configured to fit into a holder 50, which is designed to fit within the receiver 22 of brewing machine 12. In another arrangement, as one example, pod 34 is configured to fit directly into the hollow interior 26 of receiver 22 of a brewing machine 12 without the need for a holder 50.

In the arrangement shown, as one example, pod 34 is generally circular in shape when viewed from above or below. In the arrangement shown, as one example, pod 34 is cup-like in appearance when viewed from a perspective and may appear to be the same or similar exterior shape as what is commonly known in the art as a k-cup. In the arrangement shown, as one example, pod 34 includes an upper member 36 and a lower member 38.

Upper Member: Upper member 36 of pod 34 is formed of any suitable size, shape and design and is configured to close the upper end of pod 34. In the arrangement shown, as one example, the upper member 36 of pod 34 extends across the top of pod 34 creating an upper surface which appears circular in shape when viewed from above. The upper surface of pod 34 is generally planar in shape when viewed from the side.

In the arrangement shown, as one example, pod 34 has a lower member 38 which appears to be cup-like, when viewed from a perspective. The lower member 38 houses the medium 48. The lower member 38 also appears circular when viewed from the bottom. The lower member 38 is generally cylindrical with outer walls that extend downward from the upper member 36 until the sidewalls 42 reach the bottom wall 40.

In the arrangement shown, as one example, pod 34 is made of a biodegradable filter paper. The upper member 36 is made of biodegradable filter paper. The lower member 38 is comprised of biodegradable filter paper. Additionally, a sealing system is used to seal the upper member 36 to the lower member 38 such as an adhesive, stitching, gluing, welding, folding, crimping, or the like or any combination thereof. In the arrangement shown, as one example, the pod 34 keeps its form due to the shape of the lower member 38 material and the way the medium 48 is packed into the lower member 38 before, during or after the upper member 38 is adhered to the lower member.

That is, in one arrangement, pod 34 is formed exclusively of filter paper and brewing medium 48. In one arrangement, pod 34 is formed exclusively of filter paper and brewing medium 48 with a binder or sealing member that connects the upper member 36 to the lower member 38.

In the arrangement shown, as one example, pod 34 includes an upper member 36, a lower member 38, a lip 46, and a medium 48. While in one arrangement the pod 34 is made entirely of biodegradable filter paper, in the arrangement shown, other biodegradable materials are hereby contemplated for use. Additionally, while the upper member 36 is adhered to the lower member 38, in the arrangement shown, other means and/or modes of attachment are hereby contemplated for use. Other methods of attachment include but are not limited to, welding, adhering, folding, crimping, sewing or any combination thereof. In the arrangement shown, one example of a biodegradable pod 34 is presented as packed medium 48 in a biodegradable filter structure.

Upper Member:

In the arrangement shown as one example, pod 34 includes an upper member 36. Upper member 36 is formed of any suitable size, shape and design so as to facilitate enclosing the top portion of the pod. Additionally, upper member 36 is designed to facilitate the brewing process. Additionally, upper member 36 is designed so as to facilitate in extending past the sidewall 42 of the pod 34 so as to create a lip 46. In this way, upper member 36 creates a lip 46 designed to facilitate in the brewing process. Furthermore, upper member 36 is designed to adhere to the lower member 38 to form the pod 34.

In the arrangement shown, as one example, upper member 36 is generally planar when viewed from the side. Upper member 36 is generally circular, in shape, when viewed from the top and/or bottom. In the arrangement shown as one example, upper member 36 overlaps and/or extends past the outer perimeter of the sidewall 42 of lower member 38 a distance. Upper member extends past the sidewall in a continuous planar manner, in a generally perpendicular fashion to sidewall 42. In this arrangement, upper member 36 creates an outer rim and/or lip 46 which extends as an overhang from the sidewall 42 of the lower member 38 around the entire circumference.

In the arrangement shown, as one example, the lower surface of upper member 36 is in general contact with the upper surface of lower member 38. This contact remains consistent throughout the planar, circular interior of lip 46. In other words, the upper member 36 has an interior circle in general and constant contact with the lower member 38. This portion of upper member 36 and lower member 38 form an outer circumference forming the lip 46.

In the arrangement shown, a sealing system is used to seal the upper member 36 to the lower member 38 such as an adhesive, stitching, gluing, welding, folding, crimping, or the like or any combination thereof

In the arrangement shown, as one example, upper member 36 is configured in close proximity with medium 48 so as to form a tight, packed pod 34. In one arrangement, the lower surface of upper member 36 within the sidewall 42 of lower member 38 is in direct contact with the upper surface of medium 48. This configuration assists in maintaining the pods 34 shape and size. Additionally, this configuration aids in maintaining upper members 36 planar shape. The close proximity of upper member 36 also facilitates in the brewing process when the pod is used in a brewing machine 12.

Furthermore, in the arrangement shown, as one example, upper member 36 is designed to be in close proximity with the brewing medium 48. In the arrangement shown, as one example, the upper member 36 maintains the compact status of the medium 48 which facilitates the pod 34 in maintaining its shape.

Additionally, the general close proximity facilitates the brewing process because fluid flows through the upper member 36 and into the hollow interior pod 34 that houses medium 48. Conversely, a needle may pierce the upper member 36 and enter the medium 48 to facilitate the brewing process. Upper member 36 facilitates this process because upper member 36 is designed to keep its form so a needle can pierce the upper member 36 rather than press the upper member 36 and/or become entangled or otherwise fail to pierce.

In the arrangement shown, as one example, upper member 36 forms the top layer of the pod 34, facilitating in the entry of nipple of a brewing machine 12. In the arrangement shown, as one example, when the pod 34 is placed in a receiver 22 of a brewing machine 12, the nipple 28 of the cover 30 of the brewing machine 12 penetrates the top layer of the upper member 34 and enter the brewing medium 48. Thus, the configuration and functionality of the upper member 36 is important for the pod 34.

In the arrangement shown, as one example, upper member 36 is in consistent contact with the medium 48. However, upper member 36 need not be in consistent contact and may be separated from the medium 48 by an interior space. An interior space may be necessary for air infusion or other methods of brewing which call for air infusion and/or pressure to be added to the brewing process. Other methods of brewing, such as allowing for steeping within the pod 34, which requires another interior space or movement, are hereby contemplated for use.

In the arrangement shown, as one example, upper member 36 is formed of a biodegradable filter paper. However, other biodegradable materials are hereby contemplated for use. The construction of upper member 36 may be by other biodegradable materials, including but not limited to, paper, cotton, cardboard, modified bamboo, cellulosic material, bioplastic, paper fiber mix and/or any other biodegradable material, and/or any combination thereof.

In the arrangement shown, as one example, upper member 36 is adhered to the lower member 38 with a food safe adhesive. In the arrangement shown, the lip 46 is formed when the food safe adhesive bonds the biodegradable filter paper of the upper member 36 with the biodegradable filter paper of the lower member 38. However, other means or modes of sealing the upper member 36 to the lower member 38 are hereby contemplated for use. Other means of adhering and/or sealing include, but are not limited to, welding, adhering, folding, crimping, fusing, caramelizing, sewing, stitching, or any combination thereof.

Lower Member:

In the arrangement shown as one example, pod 34 includes a lower member 38. Lower member 38 is formed of any suitable size, shape and design so as to facilitate holding the brewing medium 48 within a containment area of the pod 34 as well as filtering the medium 48. In the arrangement shown, as one example, lower member 38 is designed to facilitate enclosing the bottom portion of the pod 34. In the arrangement shown, as one example, lower member 38 is designed to facilitate fitting within the receiver 22 of a brewing machine 12 or within a holder 50. Lower member 38 is formed of a biodegradable filter paper.

In the arrangement shown, as one example, lower member 38 is generally cup like in shape when viewed from the side and/or when viewed from a perspective view. The shape of lower member 38, in the example shown, is similar to that of a k-cup and/or other pod cup. In the arrangement shown, as one example, where the lower member 38 is adhered to the upper member 36, a lip 46 is formed.

In the arrangement shown, as one example, lower member includes a bottom wall 40, a sidewall 42, and a hollow interior 44. Additionally, in the arrangement shown, as one example, lower member 38 includes the medium 48. Lower member 38 is configured to facilitate enclosing the hollow interior 44 of the pod 34. Likewise, lower member 38 facilitates enclosing the medium 48 of the pod 34.

In the arrangement shown, as one example, lower member 38 forms the bottom portion of the pod 34, facilitating in the exit operation of a brewed beverage. In the arrangement shown, as one example, when the pod 34 is placed within a receiver 22 of a brewing machine 12 or within a holder 50, the brewed beverage filters through the lower member 38 before exiting the receiver 22 or holder 50 and entering a vessel 68.

In the arrangement shown, as one example, lower member 38 is configured in close proximity with medium 48 so as to form a tight, packed pod 34 of the biodegradable filter paper of lower member 38 tightly packed with medium 48. This configuration assists in maintaining the pods 34 shape and size. The close proximity of lower member 38 also facilitates in the brewing process when the pod is used in a brewing machine 12 and/or holder 50.

In the arrangement shown, as one example, lower member 38 is shaped similarly to a single-serve pod known as a k-cup. This is one shape the lower member 38 may take. Other shapes the lower member 38 may take include other shapes correlated to receivers of other single-serve brewing machines 12. Other single serve brewing machines 12 include, but are not limited to, Keurig, Nespresso, Galaxy, Hamilton, CuisineArt, and the like. Therefore, lower member 38 may take a number of different shapes so as to conform to a variety of brewing machines 12 and/or so as not to conform to a brewing machine 12 but to a manual brewing device as well. In another arrangement, as is shown in a second example, lower member 38 takes a semi-spherical shape so as to conform to a Nespresso brewing machine 12.

In the arrangement shown, as one example, lower member 38 is formed of a biodegradable filter paper. However, other biodegradable materials are hereby contemplated for use. The construction of lower member 38 may be by other biodegradable materials, including but not limited to, paper, cotton, cardboard, modified bamboo, cellulosic material, bioplastic, paper fiber mix and/or any other biodegradable material, and/or any combination thereof.

In the arrangement shown, as one example, lower member 38 is adhered to the upper member 36 with a food safe adhesive. In the arrangement shown, the lip 46 is formed when the food safe adhesive bonds the biodegradable filter paper of the lower member 38 with the biodegradable filter paper of the upper member 36. However, other means or modes of sealing the lower member 38 to the upper member 36 are hereby contemplated for use. Other means of adhering and/or sealing include, but are not limited to, welding, adhering, folding, crimping, fusing, caramelizing, sewing, stitching, gluing, or the like or any combination thereof.

Hollow Interior:

In the arrangement shown as one example, pod 34 includes a hollow interior 44. Hollow interior 44 is formed of any suitable size, shape and design so as to facilitate housing the medium 48. Hollow interior 44 is formed from the empty cavity created when upper member 36 and lower member 38 are adhered to one another at a lip 46. Hollow interior 44 is part of the lower member 36 below upper member 36. Hollow interior 44 is designed to facilitate and hold the medium 48 during shipping, and through the brewing process.

In the arrangement shown, as one example, hollow interior 44 is filled with a compacted medium 48, which may be useful in helping the pod 34 maintain its shape. In this arrangement, the compacted medium 48 fills the entirety of hollow interior 44 of pod 34 in a tight and compacted manner. In an alternative arrangement is, medium 48 may not be compacted, and instead may be relatively loose. In an alternative arrangement, the hollow interior 44 of pod 34 includes an air gap for additional steeping and/or movement of fluid throughout the medium 48 before the medium 48 is filtered by the biodegradable filter paper that forms hollow interior 44.

Lip:

In the arrangement shown as one example, pod 34 includes a lip 46. Lip 46 is formed of any suitable size, shape and design so as to facilitate providing a surface which holder 50 and/or other brewing machines 12 can grip in order to execute the brewing process. Lip 46 is also designed to facilitate the attachment of the lower member 38 to the upper member 36. Lip 46 provides a place for the upper member 36 and the lower member 38 to be adhered to one another.

In the arrangement shown, as one example, lip 46 is formed when the upper member 36 and lower member 38 overlap one another. Lip 46 is generally planar in shape when viewed from the side and extends in parallel relation with the top surface of the pod 34 and runs generally parallel to the bottom wall 56 of lower member 38. Lip 46 extends generally perpendicularly from the top of sidewall 42 away from the center of the pod 34. Lip 46 extends around the entire circumference of the pod 34 in a consistent and constant manner.

In the arrangement shown, as one example, lip 46 is made of the biodegradable filter paper that forms upper member 36 and lower member 38. Lip 46 may also include an adhesive compound which is used to adhere the upper member 36 to the lower member 38. However, other means or modes of sealing the lower member 38 to the upper member 36 are hereby contemplated for use. Other means of adhering and/or sealing include, but are not limited to, welding, adhering, folding, crimping, fusing, caramelizing, sewing, stitching, gluing, or the like, or any combination thereof.

Additionally, although lip 46 is made of biodegradable filter paper, other biodegradable materials are hereby contemplated for use. The construction of lip 46 may be by other biodegradable materials, including but not limited to, paper, cotton, cardboard, modified bamboo, cellulosic material, bioplastic, paper fiber mix and/or any other biodegradable material, and/or any combination thereof.

In the arrangement shown, as one example, lip 46 provides an extended surface around the entire periphery of the top member 36 so as to provide a gripping plane for holder 50. In the arrangement shown, as one example, holder 50 grips the lip 46 between the upper member 52 of holder 50 and the lower member 54 of holder 50 when the upper member 52 is closed onto the lip 46.

Similarly, in another arrangement, as is shown, lip 46 is designed to close and be gripped within the receiver 22 of a brewing machine 12. When lip 46 is gripped within the receiver 22, and/or between the upper member 52 of holder 50 and the lower member 54 of holder 50, a tension force is created along the upper member 36 which allows a needle or nipple 32 to penetrate the upper member 36. In the arrangement shown, as one example, the top of the sidewall of the receiver 22 pinches the lip 46 between the circumference of the top of the sidewall of the receiver 22 and a seal within the cover member 30 of the brewing machine 12. In this example, lip 46 allows for pod 34 to be used in many applications without the need for a holder 50, or alternatively, when a holder 50 is used, lip 46 allows pod 34 to be held between the upper member 52 of holder 50 and the lower member 54 of holder 50.

Medium:

In the arrangement shown as one example, pod 34 includes a medium 48. Medium 48 is formed of any size, shape and design so as to fit within the hollow interior 44 of the pod 34. Medium 48 may take any desired form of material that is to be brewed by a user. In the arrangement shown, as one example, medium 48 is formed of loose or compacted coffee grounds.

In the arrangement shown, as one example, medium 48 is formed of coffee grounds. However, any other medium 48 used in the brewing process is hereby contemplated for use, such as tea, tea leaves, whole coffee beans, cider, hot cocoa mix, and/or any other mediums 48 used for brewing. Additionally, ambient and/or filtered air may be all or part of a medium 48 or any combination of mediums 48 herein.

Rigid Sidewall Pod (35):

In another, similar embodiment including the elements herein, as in an example shown, system 10 includes pod 35. Pod 35 is shaped of any suitable size, shape or design and is designed and/or adapted to fit effectively into certain existing receiver 22 designs, such as that of a Keurig machine, as one example. Pod 35 is designed to facilitate a stronger structure as may be required for some brewing machines 12 as compared pod 34 that is completely formed of a filter-paper-type material. Additionally, pod 35 is specially facilitated to fit in close proximity with the receivers 22 of brewing machines 12.

In the arrangement shown, as one example, pod 35 includes a cover member 37, a lower member 38, an open bottom 41, a sidewall 42, a step 43, a hollow interior 44, a lip 46, and a medium 48. Pod 35 is designed to fit within a variety of machines of many shapes and sizes and designed to be biodegradable while providing a more rigid structure as compared to pod 34 presented herein.

In the arrangement shown, as one example, pod 35 is configured to fit into a receiver 22 of brewing machine 12. In the arrangement shown, as one example, pod 35 is generally circular in shape when viewed from above or below. In the arrangement shown, as one example, pod 35 is cup-like in appearance when viewed from a perspective and may appear to be the same shape as a k-cup. The cover member 37 of pod 35 extends across a portion of the top of pod 35 creating an upper surface which appears circular in shape when viewed from above. The upper surface of pod 35 is generally planar in shape when viewed from the side.

In the arrangement shown, as one example, pod 35 has a lower member 38 which appears to be cup-like, when viewed from a perspective. The lower member 38 houses medium 48 within its hollow interior 44. The lower member 38 also appears circular when viewed from the bottom. The lower member 38 is generally cylindrical with outer walls that extend downward from the lip 46 below the cover member 37 until the sidewalls 42 reach the end of the open bottom 41.

In the arrangement shown, as one example, pod 35 is made partially of a biodegradable rigid material (such as a biodegradable cardboard, or a plurality of layers of biodegradable filter paper that are pressed together to form a rigid material, or any other biodegradable rigid material) and partially of biodegradable filter paper. In the arrangement shown, as one example cover 37 is made of biodegradable filter paper, however any other material is hereby contemplated for use. In the arrangement shown, as one example bottom wall 40 is also made of biodegradable filter paper, however any other material is hereby contemplated for use. In the arrangement shown, as one example lower member 38 is comprised of mostly biodegradable rigid material as well as biodegradable filter paper. Additionally, a sealing system is used to seal the cover member 37 to the lip 46 of the lower member 38 such as an adhesive, stitching, gluing, welding, folding, crimping, or the like or any combination thereof.

In the arrangement shown, as one example, pod 35 includes a cover member 37, a lower member 38, a lip 46, and a medium 48. In the arrangement shown, as one example, lower member 38 is formed of a rigid biodegradable material such as a cardboard, card stock, paper stock, paper, cotton, modified bamboo, cellulosic material, bioplastic, paper fiber mix and/or any other biodegradable material, and/or any combination thereof. In one arrangement, the cover member 37 is adhered to the lower member 38 by a food safe adhesive. Alternatively, cover member 37 and lower member 38 are adhered or connected to one another by any other means and/or modes of attachment all of which are hereby contemplated for use. Other methods of attachment include but are not limited to, welding, adhering, folding, crimping, sewing gluing, crimping, or the like or any combination thereof. In the arrangement shown, one example of a biodegradable pod 35 is presented as packed medium 48 in a biodegradable filter structure.

Cover Member:

In arrangement shown, as one example, pod 35 includes a cover member 37. Cover member 37 is formed of any suitable size, shape and design so as to facilitate enclosing the top portion of the pod 35. Additionally, cover member 37 is designed to facilitate the brewing process. Additionally, cover member 37 is designed to facilitate in overlapping the lip 46 to create a seal and/or enclose the medium 48 within the pod 35. Furthermore, in the arrangement shown, as one example, cover member 37 is designed to adhere to the lower member 36 of the pod 35 at the lip 46.

In the arrangement shown, as one example, cover member 37 is generally planar when viewed from the side. Cover member 37 is generally circular in shape, in shape, when viewed from the top and/or bottom. In the arrangement shown, as one example, cover member 37 overlaps and/or extends past the interior of the sidewall 42. Cover member 37 extends past the sidewall 42 in a continuous planar manner, in a generally perpendicular manner to sidewall 42 and generally parallel to lip 46. In this arrangement, cover member 37 creates an added layer of the lip 46 and/or forms part of the lip 46. Cover member 37, forming part of the lip 46, extends to the outer periphery of the lip 46 around the entire circumference. Once attached, cover 37 and the lower member 38 form a hollow interior 44 that houses the brewing medium 48.

In the arrangement shown, as one example, cover member 37 is generally in contact with medium 48. This contact remains consistent throughout the planar, circular interior of lip 46. In other words, the lower surface of cover member 37 has an interior surface in general contact with the medium 48 and an outer surface overlapping and/or forming part of the lip 46, thereof. In the arrangement shown, as one example, cover member 37 is adhered to lower member 38 at the lip 46.

In the arrangement shown, as one example, cover member 37 is configured in close proximity with medium 48 so as to form a tight, packed pod 35. Additionally, this configuration aids in maintaining cover members 37 planar shape. The close proximity of cover member 37 also facilitates in the brewing process when the pod 35 is used in a brewing machine 12.

Additionally, the general close proximity or contact between cover member 37 and brewing medium 48 facilitates the brewing process as fluid flows through the cover member 37 and into the pod 35. Conversely, a needle may pierce the cover member 37 and enter the medium 48 to facilitate the brewing process. Cover member 37 facilitates this process as cover member 37 is designed to keep its form so a needle can pierce the cover member 37 rather than press the cover member or otherwise fail to pierce the cover member 37. This is accomplished by the rigid lower member 24 maintaining the cover member 37 in a generally tight and taught manner by the rigid nature of the lower member 38 in association with the connection between cover member 37 and lip 46.

Furthermore, in the arrangement shown, as one example, cover member 37 forms the top layer of the pod 35, facilitating in the entry operation of a nipple 32 of brewing machine 12. In the arrangement shown, as one example, when the pod 35 is placed in a receiver 22 of a brewing machine 12, the nipple 28 of the cover 30 of the brewing machine 12 penetrates the cover member 37 and enters the brewing medium 48.

In the arrangement shown, as one example, cover member 37 is in consistent contact with the medium 48. However, cover member 37 need not be in consistent contact with medium 48 and may be separated from the medium 48 by an interior space. An interior space may be necessary for air infusion or other methods of brewing which call for air infusion and/or pressure to be added to the brewing process. Other methods of brewing, such as allowing for steeping within the pod 35, which requires another interior space or movement, are hereby contemplated for use.

In the arrangement shown, as one example, cover member 37 is formed of a biodegradable filter paper and/or biodegradable cardboard. However, other biodegradable materials are hereby contemplated for use, including but not limited to, paper, cotton, cardboard, modified bamboo, cellulosic material, bioplastic, paper fiber mix and/or any other biodegradable material, and/or any combination thereof.

In the arrangement shown, as one example, cover member 37 is adhered to the lower member 38 with a food safe adhesive. In the arrangement shown, the lip 46 may be partially formed when the food safe adhesive bonds the biodegradable filter paper of the cover member 37 with the biodegradable filter paper of the lower member 38. However, other means or modes of sealing the cover member 37 to the lower member 38 are hereby contemplated for use. Other means of adhering and/or sealing include, but are not limited to, welding, adhering, folding, crimping, fusing, caramelizing, sewing, stitching, gluing, or the like, or any combination thereof.

Lower Member:

In the arrangement shown as one example, pod 35 includes a lower member 38. Lower member 38 is formed of any suitable size, shape and design so as to facilitate in holding the brewing medium within a hollow interior 44 of the pod 35 while providing strength and rigidity to pod 35. In the arrangement shown, as one example, lower member 38 is designed to facilitate enclosing the bottom portion of the pod 35. In the arrangement shown, as one example, lower member 38 is designed to facilitate in fitting within a tight and close proximity in the receiver 22 of a brewing machine 12.

In the arrangement shown, as one example, lower member 38 is generally cup like in shape when viewed from the side and/or when viewed from a perspective view. The shape of lower member 38, in the example shown, is similar to a k-cup and/or other pod cup. In the arrangement shown, as one example, the lower member 38 is adhered to the cover member 37. Lower member 38 also has a lip 46 which extends perpendicular to sidewall 42 at the upper most point of sidewall 42. Lip 46 extends outwardly from the center of the lower member 38, when viewed from the top, in a generally perpendicular manner to sidewall 42.

In the arrangement shown, as one example, lower member includes an open bottom 35, a bottom wall 40, a sidewall 42, a hollow interior 44, and a step 43. Additionally, in the arrangement shown, as one example, lower member 38 includes the medium 48. Lower member 38 is configured to facilitate enclosing the hollow interior 44 of the pod 35. Likewise, lower member 38 facilitates enclosing the medium 48 of the pod 35. Additionally, lower member 38 facilitates in maintaining the shape of pod 35.

In the arrangement shown, as one example, lower member 38 includes a bottom wall 40 which is made from biodegradable filter paper, a sidewall 42 made from a rigid biodegradable material, and a hollow interior 44 where the brewing medium 48 is packed or housed. Lower member 38, additionally, includes this medium 48. Lower member 38 is configured to facilitate enclosing the hollow interior 44 of the pod 35. Likewise, lower member 38 facilitates enclosing the medium 48 in the pod 35. Additionally, lower member 38 facilitates in maintaining the form of the pod 35 so the pod may be transported, and still used in the receiver the pod 35 is meant for without substantial deformation.

In the arrangement shown, as one example, lower member 38 is formed of biodegradable paper board and is adhered to cover 37 adjacent the top portion of sidewall 42 at the lip 46. In the arrangement shown, as one example, where the lip 46 is adhered to the cover 37, the sidewall 42 meets the lip 46 at the upper most portion of the sidewall when viewed from the side.

In the arrangement shown, as one example, lower member 38 forms the bottom portion of the pod 35, facilitating in the exit operation of a brewed beverage. In the arrangement shown, as one example, when the pod 35 is placed within a receiver 22 of a brewing machine 12, the brewed beverage filters through the lower member 38 before exiting the receiver 22 and entering a vessel 68.

In the arrangement shown, as one example, lower member 38 forms the bottom portion of the pod 34, facilitating in the exit operation of a brewed beverage. In the arrangement shown, as one example, when the pod 34 is placed within a receiver 22 of a brewing machine 12, the brewed beverage filters through the lower member 38 before exiting the receiver 22 and entering a vessel 68.

In the arrangement shown, as one example, lower member 38 is shaped similarly to a single-serve pod known as a k-cup. This is one shape the lower member 38 may take. Other shapes the lower member 38 may take include other shapes correlated to receivers of other single-serve brewing machines 12. Other single serve brewing machines 12 include, but are not limited to, Keurig, Nespresso, Galaxy, Hamilton, CuisineArt, and more. Therefore, lower member 38 may take a number of different shapes so as to conform to a variety of brewing machines 12 and/or so as not to conform to a brewing machine 12 but to a manual brewing device as well. In another arrangement, as is shown in a second example, lower member 38 takes a semi-spherical shape so as to conform to a Nespresso brewing machine 12.

In the arrangement shown, as one example, sidewalls 42 of lower member 38 are formed of a biodegradable cardboard material. The bottom wall 40 of lower member 38 is formed of biodegradable filter material. However, other biodegradable materials are hereby contemplated for use. The construction of lower member 38 may be by other biodegradable materials, including but not limited to paper board, filter paper, paper, cotton, cardboard, modified bamboo, cellulosic material, bioplastic, paper fiber mix and/or any other biodegradable material, and/or any combination thereof. Additionally, such a formation of materials or a similar formation assists the pod 35 in maintaining the desired shape while also maintaining the biodegradable qualities of the pod 35.

In the arrangement shown, as one example, lower member 38 is adhered to the cover member 37 with a food safe adhesive. In the arrangement shown, the lip 46 is part of the adhesive surface. The food safe adhesive bonds the biodegradable material of the lower member 38 with the biodegradable filter paper and/or biodegradable cardboard material of the cover member 37. However, other means or modes of sealing the lower member 38 to the cover member 37 are hereby contemplated for use. Other means of adhering and/or sealing include, but are not limited to, welding, adhering, folding, crimping, fusing, caramelizing, sewing, stitching, gluing, or the like, or any combination thereof.

Hollow Interior:

In the arrangement shown as one example, pod 35 includes a hollow interior 44. Hollow interior 44 is formed of any suitable size, shape and design so as to facilitate housing the medium 48. Hollow interior 44 is formed from the cavity created between cover member 37 and lower member 38. Hollow interior 44 is part of the lower member 36. Hollow interior 44 is designed to facilitate and hold the medium 48 during shipping, and through the brewing process. In addition, hollow interior 44 is designed to facilitate the brewing process. The brewing process takes place within the hollow interior 44.

In the arrangement shown, as one example, hollow interior 44 is filled with a compacted medium 48. The compact medium 48 is commonly used in the brewing process and may work under certain conditions and for certain brewing processes. However, any other arrangement of the hollow interior 44 is hereby contemplated. An example of an alternative arrangement is, but is not limited to, having a lesser packed and/or loose medium 48. Another alternative example is, but is not limited to, having an air gap and/or air pressure for additional steeping and/or movement of fluid throughout the medium 48 before the medium 48 debris is filtered by the biodegradable filter paper at the bottom of the hollow interior 44.

Lip:

In the arrangement shown as one example, pod 35 includes a lip 46. Lip 46 is formed of any suitable size, shape and design so as to facilitate providing a surface which a brewing machine 12 grips the pod 35 for the brewing process. In other words, lip 46 is a surface which holder 50 and/or brewing machine 12 grip may grip pod 35 in order to execute the brewing process. In the arrangement shown, as one example, lip 46 is adhered to the cover member 37. Lip 46 is generally planar and extends in parallel with the top surface of the pod 35 and extends in generally parallel spaced relation to bottom wall 40 of lower member 38.

Lip 46 is generally planar and extends in parallel with the top surface of the pod 35 and extends in generally parallel spaced relation to the bottom wall 40 of lower member 38. Lip 46 extends in a generally perpendicular manner from the top of sidewall 42 away from the center of the pod 35. Lip 46 extends around the entire circumference of the pod 35, when viewed from the top.

Similarly, in another arrangement, as is shown, lip 46 is designed to close and be gripped within the receiver 22 of a brewing machine 12. When lip 46 is gripped within the receiver, a tension force is created along the cover member 37 which allows a needle or nipple 32 to penetrate the cover member 37. Lip 46 is also designed to facilitate the attachment of the lower member 38 to the cover member 37. Lip 46 provides a place for the cover member 37 and the lower member 38 to be connected to one another.

In the arrangement shown, as one example, lip 46 is made of biodegradable rigid material such as a cardboard, however any other material is hereby contemplated for use. In the arrangement shown, as one example, lip 46 is sealed to cover member 37 by a food safe adhesive. However, other means or modes of sealing the lower member 38 to the cover member 37 are hereby contemplated for use. Other means of adhering and/or sealing include, but are not limited to, welding, adhering, folding, crimping, fusing, caramelizing, sewing, stitching, gluing, or the like, or any combination thereof.

Additionally, although lip 46 is made of biodegradable cardboard, other biodegradable materials are hereby contemplated for use. The construction of lip 46 may be by other biodegradable materials, including but not limited to, card stock, paper board, paper, cotton, cardboard, modified bamboo, cellulosic material, bioplastic, paper fiber mix and/or any other biodegradable material, and/or any combination thereof

Medium:

In the arrangement shown as one example, pod 35 includes a medium 48. Medium 48 is formed of any size, shape and design so as to fit within the hollow interior 44 of the pod 35. Medium 48 may take any desired form of material that is to be brewed by a user. In the arrangement shown, as one example, medium 48 is formed of loose or compacted coffee grounds.

In the arrangement shown, as one example, medium 48 is formed of coffee grounds. However, any other medium 48 used in the brewing process is hereby contemplated for use, such as tea, tea leaves, whole coffee beans, cider, hot cocoa mix, and/or other mediums 48. Additionally, ambient and/or filtered air may be all or part of a medium 48 or any combination of mediums 48 herein.

Step:

In conventional Keurig or similar machines, a needle punctures the top of the k-cup to allow water to flow into the k-cup, and a needle punctures the bottom of the k-cup to allow water to flow out of the k-cup. In the arrangement presented, with respect to pod 35, it is not desirable to have the bottom wall 40 be punctured.

As such, in the arrangement shown, as one example, bottom wall 40 of pod 35 is positioned a distance above the bottom end 82 of sidewall 42 of lower member 38. This positioning places the bottom wall 40 out of the puncturing distance of the bottom needle of Keurig or similar machines. By having the bottom end 82 of sidewall 42 extend past the bottom wall 40 a distance, this insures that the pod 35 fills and fits within the receiver 22 of the brewing machine 12, while raising the bottom wall 40 up and above the puncturing reach of the bottom needle of Keurig or similar machines.

In the arrangement shown, as one example, the interior surface of sidewall 42 of lower member 38 includes a step 43 therein. Step 43 is any feature or structure that helps facilitate the connection of bottom wall 40 to the interior surface of sidewall 42 of lower member 38 above the bottom end 82 of sidewall 42. In the arrangement shown, as one example, step 43 is an inward step from the interior surface sidewall 42 into hollow interior 44 a distance. This causes the effective diameter of the hollow interior 44 at step 43 to be less than the effective diameter of the hollow interior 44 above step 43. In this way, the bottom wall 40 may rest upon the upper surface of step 43 which serves to prevent the bottom wall 40 from sliding through the hollow interior 44 of lower member 38. In addition, the upper surface of step 43 may serve as a surface to which bottom wall 40 is connected to lower member 38.

In one arrangement, bottom wall 40 is affixed to lower member 38 by any manner, method or means. In one arrangement, bottom wall 40 is frictionally engaged with the interior surface of sidewall 42 and the upper surface of step 43 and is frictionally held in place. Alternatively, a sealing system is used to seal the bottom wall 40 to the interior surface of sidewall 42 and/or the upper surface of step 43 such as an adhesive, stitching, gluing, welding, folding, crimping, or the like or any combination thereof.

The use a rigid lower member 38 in pod 35 eliminates the need to use a holder 50 as the rigid nature of the lower member 38 tends to hold the shape of the pod 35. As such, due to the dimensional accuracy and its resistance to deformation, pod 35 may be reliably used in association with brewing machine 12 without the need to use holder 50 to ensure dimensional accuracy.

Holder:

In the arrangement shown, as one example, system 10 includes a holder 50. Holder 50 is formed of any size, shape and design so as to facilitate holding and/or supporting pod 34 during the brewing operation. Holder 50 is designed to be reusable. In the arrangement shown, as one example, holder 50 includes an upper member 52 with a needle receiving member 53 therein, a lower member 54 with a bottom wall 56, a sidewall 58, and a hollow interior 60. In the arrangement shown, as one example, holder 50 also has a hinge 66 that is designed to facilitate with opening and closing the upper member 52 to the lower member 54, however any other arrangement of connecting upper member 52 to lower member 54 is hereby contemplated for use such as a snap-fit arrangement, a threaded arrangement or the like or any other manner of connecting two components together. Hinge 66 also facilitates in the attachment of the upper member 52 to the lower member 54.

In the arrangement shown as one example, holder 50 includes an upper member 52. Upper member 52 is formed of any suitable size, shape and design so as to facilitate in creating an enclosed interior, a hollow interior 60, and to create a frictional seal between the lip 46 and the lower member 54. In the arrangement shown, as one example, upper member 52 is generally planar in shape. When in a closed position, upper member 52 extends in a generally parallel arrangement with bottom wall 56 of the lower member 54 of the holder 50. In the arrangement shown, as one example, upper member 52 is generally circular when viewed from above. In the arrangement shown, as one example, upper member 52 has a needle receiving member 53 positioned at its approximate middle, when viewed from above. Also, in the arrangement shown, as another example, upper member 52 includes a receiving aperture 65, capable of receiving a nipple 32 of cover 30 of brewing machine 12.

In the arrangement shown, as one example, upper member 52 is designed to facilitate the entry of fluid into the holder 50. In the arrangement shown, as one example, upper member 52 comprises a needle receiving member 53. Needle receiving member 53 is formed of any suitable size, shape and design and is designed to facilitate entry of the fluid into the holder 50. In the arrangement shown, as one example, upper member 52 includes a grated fluid aperture allowing fluid to permeate into the upper member 36 of the pod 34. In another arrangement, as is shown, upper member 52 includes a receiving aperture 65 of upper member 52 designed so as to facilitate in receiving a needle or nipple 32 of a brewing machine 12. The receiving aperture 65 of the example, as shown, allows a nipple to penetrate through the receiving aperture 65 and penetrate the upper member 36 of the pod 34.

In the arrangement shown as one example, holder 50 includes a lower member 54. Lower member 54 is formed of any suitable size, shape and design so as to facilitate holding the pod 34 throughout the brewing process. In the arrangement shown, as one example, lower member 54 includes a bottom wall 56, a sidewall 58, a hollow interior 60, a screen member 62, and a needle receiving member 64.

In the arrangement shown, as one example, lower member 54 is generally cup-like in shape with a bottom wall 56 which is generally planar and extends in approximate parallel spaced relation with a upper member 52 when the upper member 52 is in the closed position. Bottom wall 56 is generally circular when viewed from below. In the arrangement shown, as one example, sidewall 58 extends upwardly from the periphery of bottom wall 56 creating a hollow interior 60. Both bottom wall 56 and sidewall 58 include one or more sections of screen member 62. In the arrangement shown, as one example, four sections of screen member 62 are placed in sidewall 58 and bottom wall 56. In the arrangement shown, as one example, sidewall 58 also extends downward at the periphery of the bottom wall 56 creating a hollow space in the bottom of the cup-like shape. This hollow space in the bottom is the needle receiving member 64 of lower member 54.

In the arrangement shown, as one example, lower member 54 is generally cup-like in shape with the similarity of a k-cup, however any other shapes are hereby contemplated for use. Lower member 54 may be semi-spherical in shape to be housed within a Nespresso machine, as is shown in one embodiment. Lower member 54 may also be other shapes so as to be accommodated in other brewing machines 12 and or brewing methods.

In the arrangement shown, as one example, lower member includes a bottom wall 56. Bottom wall 56 is formed of any suitable size, shape, and design and is designed to facilitate holding the pod 34 within the hollow interior 60 of the holder 50. In the arrangement shown, as one example, bottom wall 56 is formed of sections of solid material and sections of screen member 62 which provides a structural integrity to the bottom wall 56 while also allowing fluid to flow through the bottom wall 56 In the arrangement shown, as one example, lower member includes a sidewall 58. Sidewall 58 is formed of any suitable size, shape and design and is designed to facilitate holding the pod 34 within the hollow interior 60 of the holder 50. In the arrangement shown, as one example, sidewall 58 is formed of sections of solid material and sections of screen member 62 which provides a structural integrity to the sidewall 58 while allowing fluid to flow through the sidewall 58. In the arrangement shown, as one example, sidewall 58 is connected to bottom wall 56 and extends downwardly past bottom wall 58 a slight distance.

In the arrangement shown, as one example, lower member includes one or more screen members 62. Screen members 62 are formed of any suitable size, shape and design and is designed to facilitate to allow water to pass there through, while preventing solid materials from passing there through. In the arrangement shown, as one example, screen member 62 lines the walls of the bottom wall 56 and of the sidewall 58. Screen member 62 along the bottom wall 56 takes the form of the bottom wall 56 in that the screen members 62 are generally planar with the bottom wall 56 surface, and in the arrangement shown forms four windows in the bottom wall 56. Similarly, screen member 62 takes the shape of the sidewall 58 in that screen member is circular in shape when viewed from the top or bottom, and in the arrangement shown forms four windows in the sidewall 58. Screen member 62 helps give the lower member 54 the cup-like appearance, when viewed from a perspective.

In the arrangement shown, as one example, screen member 62 is formed of a mesh like material so as to allow fluid to flow through the screen but to retain medium 48 within the hollow interior 60 of the holder 50.

In the arrangement shown as one example, holder 50 includes a hinge 66. Hinge 66 is formed of any suitable size, shape and design so as to facilitate closing the pod 34 within the hollow interior 60 of the holder 50. In the arrangement shown, as one example, hinge 66 is formed of a flexible material that allows for repeated use, alternatively, hinge 66 is formed of a mechanical hinge arrangement, such as a barrel hinge or the like. Any other form of a hinge member is hereby contemplated for uses as hinge 66. Hinge 66 attaches the upper member 52 of holder 50 to the lower member 54 of holder.

In the arrangement shown, as one example, hinge 66 is attached for only a small portion of the periphery of the upper member 52 of holder 50. Hinge 66 is flexible enough to allow the upper member 52 to open completely, removing the upper member 52 from the lower member 54 by axial rotation of the hinge 66. Hinge 66 also allows the upper member 52 to become fully engaged with the lower member 54.

Hinge 66 is formed of a flexible polymer in the arrangement shown. However, any other manner, method or means for connecting the upper member 52 to the lower member 54 is hereby contemplated. A flexibly polymer allows for the upper member 52 and the lower member 54 to be quickly and easily connected and disconnected thus exposing or enclosing the hollow interior 60 of the holder 50 for insertion of a pod 34 and/or ejection of a pod 34.

In the arrangement shown, as one example, lower member 54 includes a needle receiving member 64. Needle receiving member 64 is formed of any suitable size, shape and design and is configured to facilitate creating a space at the bottom of the holder 50 for which a needle or nipple 28 of the lower member 24 of a brewing machine 12 may press into. Many brewing machines 12 have a small puncture needle or nipple 28 which pressed into the bottom of a pod 34 or k-cup to puncture the bottom of the k-cup. This is undesired in brewing machines 12 when the holder 50 or pod 34, 35 is being used as the device for filtering. Therefore a space is desirable at the bottom of the holder 50 so the needle or nipple 28 do not pierce the holder 50.

Method of Operation Pod with Holder:

In operation, a brewing medium 48 is converted to a brewed beverage by a brewing machine 12 by adding heated fluid and/in some cases pressure as well.

One mode of brewing a medium 48 is by brewing a single cup at a time. This is desirous because it is quicker than brewing a large amount, such as an entire pot of coffee. The single-serve option is also easier than creating a larger portion. A single-serving size also reduces waste when the remainder isn't consumed. Single serve pods have become well-known in the art for their ease of use. However, single serve pods, known in the art, are environmentally unfriendly as they have substantial amounts of waste.

The operation of the present disclosure involves a single serve pod that is environmentally friendly. The single-serve pod is biodegradable. Pod 34, 35 is capable of creating a brewed beverage by the use of a brewing machine 12 and/or possibly other methods. A pod 34, 35 includes an upper member 36, a lower member 38, and potentially a holder 50 which aid in the brewing process.

In one arrangement, as is shown, a pod 34 is inserted into a holder 50. More specifically, a pod 34 having an upper member 36 and a lower member 38 may be aided in the brewing process by utilizing a reusable holder 50. The upper member 36 and the lower member 38 of the pod overlap one another at a lip 46. Once the pod 34 is placed within the hollow interior 60 of the holder 50, the upper member 52 of holder 50 is closed down on the lip 46 securing the pod 34 in place.

The holder 50 has an upper member 52 and a lower member 54. Upper member 52 is hingedly connected to lower member 54 by a hinge 66. The upper member 52 is in the open position by rotating the upper member 52 about the hinge 66 to the open position which exposes the hollow interior 60 of holder 50. Once holder 50 is opened, pod 34 can be placed into the hollow interior 60 of the holder 50. The hollow interior 60 of the holder 50 then holds the pod 34 therein. The hollow interior 60 is lined with a screen member 62 which would catch any escaping medium 48.

In this arrangement, although the screen member 62 of the holder 50 may catch any escaping debris, the upper member 36 and the bottom member 38 of the pod 34 are formed of a biodegradable filter material, which is meant to retain the medium 48. In operation, the biodegradable filter material retains the medium 48 within the pod 34.

Once the pod 34 is placed into the holder 50, when using a holder 50 is used to assist with the brewing process, the upper member 52 of the holder 50 is closed. The upper member 52 frictionally engages the lip 46 of the pod 34 between the upper member 52 of the holder 50 and the top of the sidewall 58 of the lower member 54 of the holder 50. Thus, the pod 34 is generally fixed in position within the holder 50 between the upper member 52 and the lower member 54. That is, the lip 46 of the pod 34 becomes frictionally fixed between a grip created by the upper member 52 and the lower member 54 of holder 50. The upper member 52 and the lower member 54 hold the pod 34 in place by a pressure created when the upper member 52 is closed on lower member 54. This pressure and hold establishes a tension across the upper member 36 or cover member 37 of pod 34, 35 which helps to ensure that that the upper member 36 or cover member 37 are held in their precisely desired position.

When the pod 34 is secured within the hollow interior 60 of the holder 50, the holder 50 is then placed in the receiver 22 of brewing machine 12. After the holder 50 and pod 34 combination is placed within the receiver 22, the brewing machine 12 may need to be closed around the holder 50. Not all brewing machines 12 require this step but most do. In the arrangement shown, as one example, the lower member 24 of brewing machine 12 is closed in conjunction with the cover member 30 of brewing machine 12 by pulling down on a lever 25 located above the cover member 30 of brewing machine 12. The lever 25 engages contact between the cover member 30 and the lower member 24 and encloses the holder 50 within the machine.

Following closing the holder 50 within the brewing machine 12, an automated brewing process can be initiated. A button 15 is pressed on the main body 14 of the brewing machine 12 to indicate the corresponding vessel 68 size to be filled with the brewed beverage. The selection begins the automated brewing process which involves delivering water to the pod 34 within the holder 50 within the receiver 22 within the brewing machine 12. Fluid, generally water, flows from the water container 16 of the brewing machine 12 to be warmed by the heating system 18 of the brewing machine 12. After the water is warmed it flows to the water delivery system 20 of the brewing machine 12.

The water delivery system 20 of brewing machine 12 may include a nipple 32. Nipple 32 may be dull or sharp depending on the brewing machine 12. Some brewing machines 12 require the nipple 32 to pierce through the top of the pod 34 while others may not require a piercing but a dispersing of fluid at the upper member 36 of the pod 34. Nipple 32 is part of the cover member 30 of the brewing machine 12. It is here, where the fluid is passed into the top of the holder where the fluid enters into the upper member 36 of the pod 34 and infiltrates the brewing medium 48.

The fluid then passes through and/or into the medium 48 within the hollow interior 44 of lower member 38 of the pod 34. Here, a brewing process actually takes place where nutrients and/or other particles are merged by a process of equilibrium and pressure. Fluid, generally water, is able to adsorb nutrients and retain those nutrients and/or other materials from the medium 48. Pressure and/or other combinations also can enhance or change this extraction process.

After extraction, gravity and pressure force the brewed fluid through the bottom wall 40 of the pod 34, and when the sidewall 42 of lower member 38 is also formed of a filter material, then through sidewall 42 as well. The biodegradable filter material retains the medium 48 while allowing the brewed fluid to flow through. The biodegradable filter material also filters the fluid of debris as the fluid moves out of the pod 34. Additionally, the fluid is filtered by the screen member 62 of the holder 50 when the brewed beverage passes through either the sidewalls 58 of the holder 50 or through the bottom wall 56 of the holder 50.

The screen member 62 provides a final catch and/or screening for removing medium 48 and/or other debris that may need removed from the fluid. The fluid then passes through another nipple 28 located at the bottom of the receiver 22 of lower member 24 of the brewing machine. Exiting the nipple 28, the fluid is pulled by gravity downward into a vessel 68.

Method of Operation without a Holder/Pod Only:

In an operation where pod 33, 34, 35 is used without a holder 50, the brewing machine 12 secures the pod 33, 34, 35 in place at the lip 46. In operation, a brewing medium 48 is converted to a brewed beverage by a brewing machine 12 by adding fluid and in some cases pressure.

One mode of brewing a medium 48 is by brewing a single cup at a time. This is desirous because it is quicker than brewing a large amount, such as an entire pot of coffee. The single-serve option is also easier than creating a larger portion. A single-serving size also reduces waste when the remainder isn't consumed. Single serve pods have become well-known in the art for their ease of use. However, single serve pods, known in the art, are environmentally unfriendly causing plastic to fill landfills. Single serve pods known in the art are not recyclable.

The operation of the present disclosure involves a single serve pod that is environmentally friendly. The single-serve pod is biodegradable. Pod 33, 34, 35 is capable of creating a brewed beverage by the use of a brewing machine 12 and/or possibly other methods. A pod 33, 34, 35 includes an upper member 36, and a lower member 38.

In one arrangement, as is shown, a pod 33, 34, 35 need not be inserted in a holder 50. More specifically, the upper member 36 and the lower member 38 of the pod overlap one another at a lip 46. Once the pod 33, 34, 35 is placed within the receiver 22 of the brewing machine 12, the pod 33, 34, 35 is ready for the brewing process.

Once the pod 33 is placed into the receiver 22 of the brewing machine 12, the brewing machine 12 is closed securely around the pod 33, 34, 35. The cover member 30 frictionally engages the lip 46 of the pod 33, 34, 35 between the cover member 30 of the brewing machine 12 and the top of the sidewall 58 of the receiver 22 of the lower member 24 of the brewing machine 12. Thus, the pod 33, 34, 35 is generally fixed in position within the receiver 22 between the cover member 30 and the lower member 24. That is, the lip 46 of the pod 33, 34, 35 becomes frictionally fixed between a grip created by the cover member 30 and the lower member 24. The cover member 30 and the lower member 24 hold the pod 33, 34, 35 in place because a pressure is created when the cover member 30 is closed.

After the pod 33, 34, 35 is placed within the receiver 22, the brewing machine 12 may need to be closed around the pod 33, 34, 35. Not all brewing machines 12 require this step but most do. In the arrangement shown, as one example, the lower member 24 of brewing machine 12 is closed in conjunction with the cover member 30 of brewing machine 12 by pulling down on a lever 25 located above the cover member 30 of brewing machine 12. The lever 25 engages contact between the cover member 30 and the lower member 24 and encloses the holder 50 within the machine.

Following closing the pod 33, 34, 35 within the brewing machine 12, an automated brewing process can be initiated. A button 15 is pressed on the main body 14 of the brewing machine 12 to indicate the corresponding vessel 68 size to be filled with the brewed beverage. The selection begins the automated brewing process which involves delivering water to the pod 33, 34, 35 within the receiver 22 within the brewing machine 12. Fluid, generally water, flows from the water container 16 of the brewing machine 12 to be warmed by the heating system 18 of the brewing machine 12. After the water is warmed it flows to the water delivery system 20 of the brewing machine 12.

The water delivery system 20 of brewing machine 12 may include a nipple 32. Nipple 32 may be dull or sharp depending on the brewing machine 12. Some brewing machines 12 require the nipple 32 to pierce through the top of the pod 33 while others may not require a piercing but a dispersing of fluid at the upper member 36 of the pod 33, 34, 35. Nipple 32 is part of the cover member 30 of the brewing machine 12. It is here, where the fluid is passed into the top of the holder where the fluid enters into the upper member 36 of the pod 33 and infiltrates the brewing medium 48.

The fluid then passes through and/or into the medium 48 within the hollow interior 44 of lower member 38 of the pod 33. Here, a brewing process actually takes place where nutrients and/or other particles are merged by a process of equilibrium and pressure. Fluid, generally water, is able to adsorb nutrients and retain those nutrients and/or other materials from the medium. Pressure and/or other combinations also can enhance or change this extraction process.

After extraction, gravity among other pressure elements of fluid flow will force the brewed fluid through the bottom of the pod 33. The biodegradable filter material retains the medium 48 while allowing the brewed fluid to flow through. The biodegradable filter material also filters the fluid of debris as the fluid moves out of the pod 33.

The fluid then passes through another nipple 28 located at the bottom of the receiver 22 in of lower member 24 of the brewing machine. Exiting the nipple 28, the fluid is pulled by gravity downward into a vessel 68.

During the brewing process, the pressure between lower member 24 and the cover member 30 of brewing machine 12 on the lip 46 of pod 33, 34, 35 holds the cover 30 of pod 33, 34, 35 in place and under tension. Similarly, during the brewing process, the pressure between lower member 24 and the cover member 30 of brewing machine 12 on the lip 46 of pod 33, 34, 35 holds the lower member of pod 33, 34, 35 in place. As such, the use of lip 46 ensures proper placement and positioning within brewing machine 12.

In the arrangement wherein sidewall 42 of lower member 38 of pod 35 is formed of a rigid material, during use, the engagement between bottom wall 40 and step 43 helps to hold bottom wall 40 within the hollow interior 44 of lower member 38 and prevents bottom wall 40 from sliding out the bottom end 82 of sidewall 42. In addition, by using a rigid lower member 38 this ensures dimensional accuracy of the pod 34 thereby ensuring a proper fit within receiver 22.

Coating:

In the arrangement shown, as one example, when lower member 38 is formed of a flexible material, such as filter paper, a coating is applied to the flexible material of the lower member 38 to help hold its shape. This coating may be any material such as a starch, a collagen, an organic material, an inorganic material, or any other material. In one arrangement, while this coating helps to hold the shape of the lower member 38 and/or the entire pod 34, in one arrangement this coating does not prevent the flow of fluid through the lower member 38 in use.

In an alternative arrangement, a process is applied to the lower member 38 to help it hold its shape. This process may be any process such as a heat treatment, a chemical process, a physical process (such as compression), any chemical, mechanical or environmental process or any other process. Like the coating process described above, while this process helps to hold the shape of the lower member 38 and/or the entire pod 34, in one arrangement this process does not prevent the flow of fluid through the lower member 38 in use.

Low-Waste System for Transporting a Plurality of Pods:

With reference to the figures, a low-waste system for transporting a plurality of pods 70 (or simply system 70) is presented. The low-waste system for transporting a plurality of pods 70 is formed of any suitable size, shape and design and is configured to facilitate transporting a plurality of pods 80 while maintaining the form of the pods 33, 34, 35 and/or maintaining no-waste and/or low-waste used in transporting a plurality of pods 80. In the arrangement shown, as one example, a low-waste system for transporting a plurality of pods 70 includes a bag 72, and a plurality of pods 80.

Bag:

In the arrangement shown, as one example, system 70 includes a bag 72. Bag 72 is formed of any size, shape and design so as to facilitate in transporting a plurality of pods 70. In the arrangement shown, as one example, bag 72 is generally square in shape when viewed from the side. However, other shapes of bag 72 are hereby contemplated for use such as circular, rectangular, trapezoidal, octagonal, or other shapes that might be used as bag 72 shapes in shipping and/or transporting. In the arrangement shown, as one example, bag 72 is generally transparent or clear where any items housed within the hollow interior 78 of the bag 72 would be visible to a user.

In the arrangement shown, as one example, bag 72 includes a sidewall 74, a sealing member 76, and a hollow interior 78. In the arrangement shown, as one example, bag 72 includes two sidewalls 74. Sidewalls 74 are formed of any size, shape and design so as to facilitate in providing the main outer covering and structure of bag 72. The two sidewalls 74 are sealed to one another along the edges of the sidewall 74 when viewing the bag 72 from the side. In the arrangement shown, as one example, the bag 74 is a square and three of the edges feature two sidewall 74 edges that are permanently sealed to one another while the fourth edge of the two sidewalls 74 forms a sealing member 76.

In the arrangement shown, as one example, bag 72 includes a sealing member 76. Sealing member 76 is formed of any suitable size, shape and design and is designed to provide an opening of the bag 72 that can be sealed and opened repeatedly. In one embodiment, bag 72 includes a sealing member 76 attachment which slides along the length of the sealing member 76, sealing the edge when slid in one direction and unsealing the edge when slid in the opposing direction. In other words, the sealing member 76 facilitates in opening, closing and resealing the hollow interior 80. Additionally, sealing member 76 preserves freshness of the plurality of pods 80.

Further, in the arrangement shown, bag 72 includes a hollow interior 78. Hollow interior 78 is formed of any suitable size, shape and design and is designed to facilitate in accommodating a plurality of pods 80. Hollow interior 78 is the formed by the two sidewalls 74 of bag 72. Hollow interior 78 is formed when the edges of the sidewalls 74 are sealed together. Hollow interior 78 provides a space for the plurality of pods 80 to be stored during transport. Hollow interior 78 is opened, closed and resealed by the sealing member 76.

In the arrangement shown, as one example, system 70 includes a plurality of pods 80. Plurality of pods 80 are formed of any suitable size, shape and design and are designed to maintain their shape and fit into the hollow interior 78 of bag 72. The plurality of pods 80 may include one or more pods. The plurality of pods 80 are transported in the bag 72, thus a plurality of pods 80 can be stored, shipped, and reduce the amount of waste.

Plurality of Pods:

Plurality of pods 80 may comprise a plurality of the pods 33, 34, 35 disclosed herein and/or any other plurality of pods used in the single-serve brewing process, including but not limited to, k-cups, coffee pod replacements, espresso pods, Hamilton beach personal pods, k-mini single serve k-cups, and/or other Keurig pods and/or other single serve brewing pods.

Bulging Upper Member:

In one arrangement, upper member 36 of pod 33, 34, 35 extends in a generally planar manner. This planar arrangement of upper member 36 has been tested with effectiveness.

However, in an alternative arrangement, pod 33, 34, 35 is packed with medium 48 in such a manner that the upper member 36 bulges slightly above a flat plane and away from lower member 38 in a generally convex manner. This convex bulging arrangement of upper member 36 of pod 33 has been tested with success and helps to facilitate penetration of a needle of brewing machine 12 through the material of upper member 36. That is, when upper member 36 is generally planar in shape, when the needle of brewing machine 12 presses down upon upper member 36 due to the planar shape of upper member 36 the needle of brewing machine 12 has a tendency to depress the upper member 36 slightly. If there is too much give in the upper member 36, the needle of brewing machine 12 may depress upper member 36 without actually penetrating through the material of upper member 36. If this occurs, the hot water will not be directly injected into the medium 48 thereby providing sub-optimal brewing results.

By over-packing pod 33, 34, 35 such that upper member 36 bulges upward in a convex manner, this ensures that the pod 33, 34, 35 is packed tightly enough that there is adequate support, by medium 48, behind upper member 36 such that when the needle of brewing machine 12 presses downward on the upper member 36, the needle penetrates upper member 36, instead of merely pressing it downward. Another benefit of this arrangement is that it ensures engagement of the needle of brewing machine 12 with upper member 36. While dimensional tolerances are important to manage, so that the pod 33, 34, 35 fits within holder 50 and/or receiver 22, it is better to have additional engagement or excess engagement between the needle of brewing machine 12 and upper member 36 rather than no engagement or not enough engagement between the needle of brewing machine 12 and upper member 36 of pod 33, 34, 35. In this way, having a convex upper member 36 provides a more-robust pod 33, 34, 35 and ensures a higher level of needle penetration.

By over packing pod 33, 34, 35 this also provides some addition leeway in the event that the medium 48 volumetrically shrinks, such as from drying out or the like. This also provides some additional leeway in the event that the bottom wall 40 or sidewall 40 or other portion of pod 33, 34, 35 bulges, deforms or otherwise changes dimensions, such as during shipping, storage or the like.

Needle Stop:

In one arrangement, bottom wall 40 of lower member 38 of pod 33, 34, 35 is formed of a material that is easily penetrable by a lower needle of brewing machine 12, such as a coffee-filter paper, fabric or other easily penetrable material. It is undesirable to have the lower needle of brewing machine 12 penetrate pod 33, 34, 35 as then the lower needle of brewing machine 12 would directly access medium 48 contained within the hollow interior 44 of lower member 38, which could cause leakage of medium 48 (such as coffee grounds or tea leaves or the like) into vessel 68, which is undesirable.

In one arrangement, pod 33, 34, 35 is configured such that bottom wall 40 of lower member 38 is raised up above and out of the reach of the lower needle of brewing machine 12 such that when pod 33, 34, 35 is placed within brewing machine 12 the lower needle does not penetrate bottom wall 40. However, in some situations, such as when pod 33, 34, 35 has been improperly inserted or overly-inserted into brewing machine 12, or when the dimensions of pod 33, 34, 35 have been deformed due to shipping, storage or the like, the bottom wall 40 of lower member 38 may be in jeopardy of being punctured by the lower needle of brewing machine 12.

In one arrangement, to prevent puncture of bottom wall 40 of lower member 38 of pod 33, 34, 35, a needle stop is placed on or in or in association with bottom wall 40 of lower member 38, or on any other portion of pod 33, 34, 35 as may be desired. This needle stop is configured to be placed at the point where a needle of brewing machine 12 may engage or is at risk of engaging pod 33, 34, 35 where penetration of pod 33, 34, 35 is not desired.

This needle stop may be formed of any configuration and/or material that is strong enough to be engaged by a needle of brewing machine 12, yet it will not be penetrated by the needle of brewing machine 12 when it is engaged by a needle. In one arrangement, needle stop is formed of a hardened plastic material that is not punctured or not easily punctured by a needle of brewing machine 12. In another arrangement, needle stop is formed of a piece of biodegradable hardened material such as a piece of compressed cardboard, or compressed paper board, or compressed paper, compressed shell or wood material, or the like. Any other structurally rigid material that is biodegradable that prevents the penetration of a needle of brewing machine 12 is hereby contemplated for use.

In one arrangement, as one example, such as in a Keurig brewing machine, needle stop is placed at the approximate center of bottom wall 40 of lower member 38 and covers only a portion of the bottom wall 40 such as, for example, a circular, square, rectangular or other shaped portion positioned at the approximate middle, or other portion, of the bottom wall 40. In this position, if the lower needle of the brewing machine 12 engages the bottom wall 40 of lower member 38 the needle engages the needle stop which prevents penetration of the bottom wall 40. In another arrangement, the entire bottom wall 40 is covered by needle stop. In another arrangement, any portion of bottom wall 40, sidewall 42 and/or any other portion of pod 33, 34, 35 may be covered wholly or partially by a needle stop which may take on any shape and configuration.

When present, the needle stop prevents insertion of a needle of brewing machine 12 into the pod 33, 34, 35 as well as preventing the passage of water out of the hollow interior 44 of pod 33, 34, 35. By preventing water from passing out of portions of pod 33, 34, 35 this increases the pressure of the water within the pod 33, 34, 35 and can increase the turbulence of the water within the pod 33, 34, 35 which can have a tendency of increasing amount of mixing between medium 48 and the water which can lead to enhanced brewing. As such, the presence of needle stop in pod 33, 34, 35 may improve operational results as well as prevent needle penetration.

As an example, when bottom wall 40 is entirely covered by a needle stop this prevents the passage of water through the bottom wall 40, which, due to gravity, is the natural path for water to travel through pod 33, 34, 35. As such, upon injection of the water into pod 33, 34, 35, the water may hit the needle stop in the bottom wall 40 and then seek a different path out of pod 33, 34, 35, such as through sidewall 42. This increases the path the water takes through pod 33, 34, 35, and increases the mixing between water and medium 48 thereby producing a fuller brew.

In one arrangement, needle stop is impenetrable to water. In alternative arrangement, needle stop may be penetrable to water, such as having holes in it or portions that allow water to pass through the needle stop while still preventing penetration of the needle.

In another arrangement, a layer of material may be placed on all or parts of the bottom wall 40, side wall 42, upper member 36 or any other portion of pod 33, 34, 35 that is impenetrable to water, but may not be impenetrable to a needle. This is useful when it is desired to increase the pressure within pod 33, 34, 35 by covering portions of pod 33, 34, 35 that are not in jeopardy of being punctured by a needle of brewing machine. This may be thinner layer of the same material used as a needle stop, such a plastic material, a piece of biodegradable water impenetrable material such as a piece of compressed cardboard, or compressed paper board, or compressed paper, compressed shell or wood material, or the like.

Nespresso Machine Arrangement:

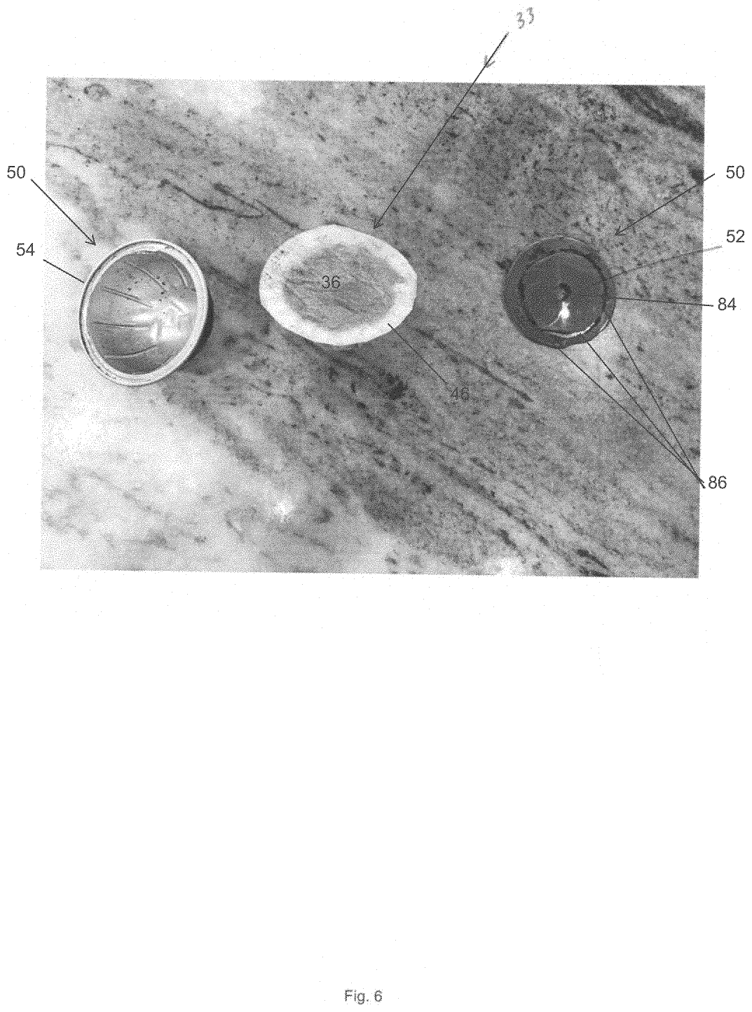

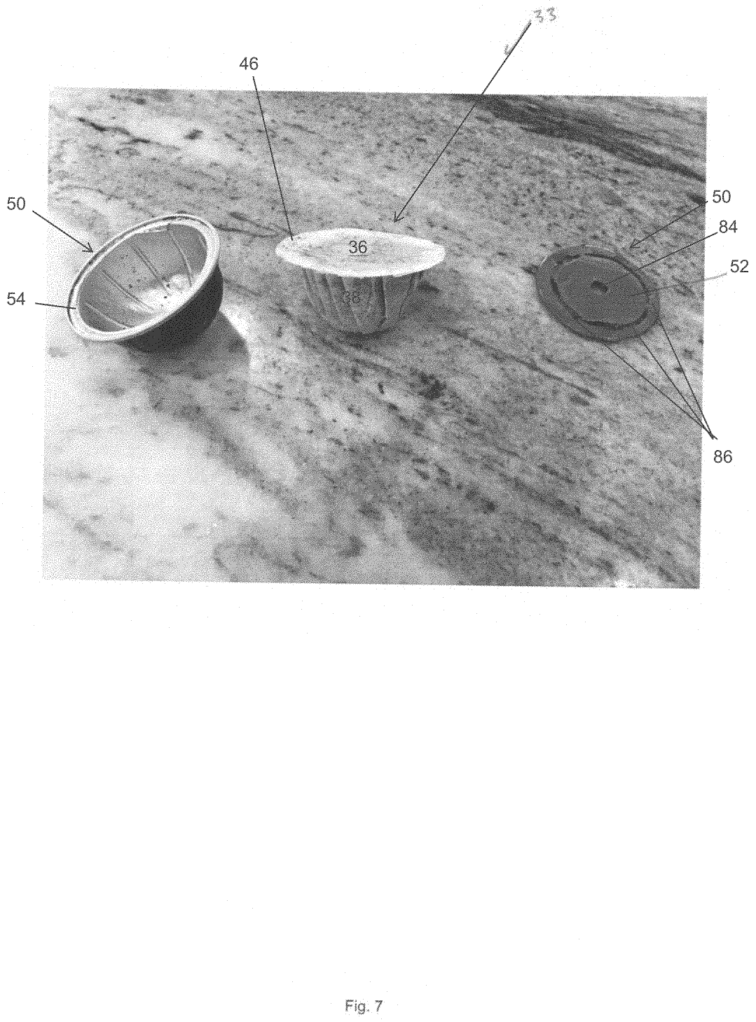

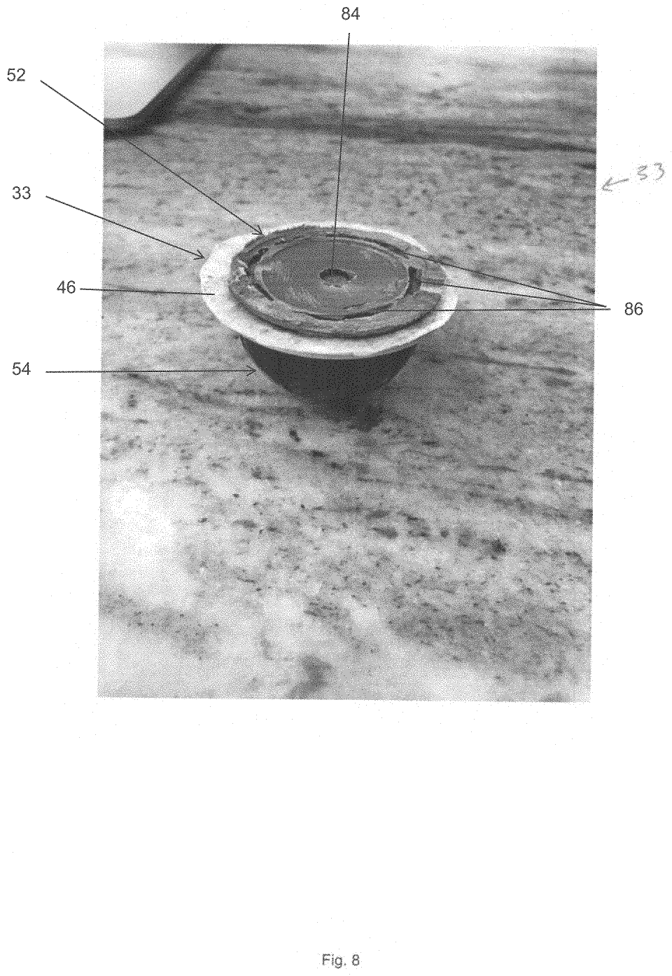

With particular reference to FIGS. 6, 7 and 8, a pod 33 is shown for use with what is known as an Nespresso brewing machine 12. Nespresso brewing machines 12 are similar to other brewing machines 12, like Keurig machines, with one difference being that the pod 33 and holder 50 rotate within the brewing machine 12 during brewing. In addition, the lower member 54 of holder 50 is not penetrated and instead the injection needle inserts through the approximate center of the upper member 52 of holder 50 to facilitate entry of water into pod 33 and multiple other needles insert along the outer edge of the upper member 52 of holder 50 to facilitate the exit of water out of pod 33.

In this arrangement, disposable and biodegradable pod 33 is similar to those described herein with the difference being that pod 33 is sized and shaped to fit within the unique shape of the holder 50 for an Nespresso brewing machine 12.

In the arrangement shown, upper member 52 of holder 50 is configured to accommodate the center injection needle of the brewing machine 12 with center cut out 84. Center cut out 84 is formed of any suitable size shape and design and is configured to allow center injection needle to pass through upper member 52 of holder 50 so that it may penetrate the upper member 36 of pod 33 to allow injection of water into the pod 33. In the arrangement shown, as one example, center cut out 84 is a generally cylindrical or circular opening positioned at the approximate middle of upper member 52. However any other shape or configuration is hereby contemplated for use.

In the arrangement shown, upper member 52 of holder 50 is configured to accommodate the insertion of a plurality of needles of the brewing machine 12 along the sides of upper member 52 through side cut outs 86. Side cut outs 86 are formed of any suitable size shape and design and are configured to allow a plurality of needles to pass through upper member 52 of holder 50 so that it may penetrate the upper member 36 of pod 33 to allow the passage of water out of pod 33. In the arrangement shown, as one example, side cut outs 86 are generally curved or arcuate openings positioned along the outward edges of upper member 52. However any other shape or configuration is hereby contemplated for use.

In this arrangement, pod 33 is placed in the lower member 54 of holder 50 and the upper member 52 is placed on top of the upper member 36 of pod 33. In this position, the lip 46 of pod 33 is captured between an upper edge of lower member 54 of holder 50 and the lower surface of the outer edge of upper member 52 of holder 50 which securely holds pod 33 therein. Once pod 33 and holder 50 are inserted into the brewing machine 12, the center injection needle passes through the center cut out 84 and penetrates the upper member 36 of pod 33 which facilitates injection of water into pod 33, and needles pass through the side cut out 86 and penetrates (or in an alternative arrangement do not penetrate) the upper member 36 of pod 33 which facilitates the passage of water out of pod 33. In this way, a biodegradable pod 33 is used in association with a holder 50 in an Nespresso brewing machine 12.

Alternative Arrangements of Connecting Upper Member to Lower Member of Holder:

Holder 50 includes an upper member 52 and a lower member 54 which connect to one another. In one arrangement, lip 46 of pod 33, 34, 35 is captured, pinched or held by the connection point between upper member 52 and a lower member 54 of holder 50. This ensures that the upper member 36 of pod 33, 34, 35, is accurately positioned such that it may be penetrated by an upper needle of the brewing machine 12 during use.

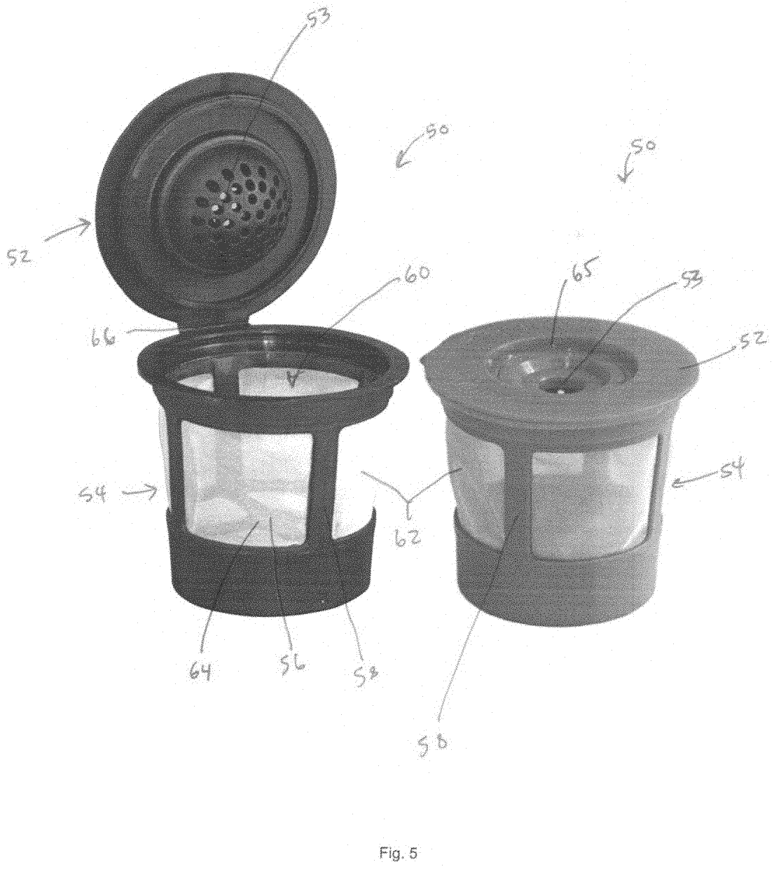

In one arrangement, as is shown in FIG. 5, upper member 52 inserts within lower member 54. That is, in the arrangement shown, as one example, upper member 52 has a ridge or edge or ring that inserts within the upper end of lower member 54 thereby forming a frictional locking engagement between upper member 52 and a lower member 54. That is, as one example, as is shown in FIG. 5, the lower surface of upper member 52 includes a ring. When upper member 52 is placed on upper member the lower and outward edges of this ring engage a similar but oppositely shaped step in the upper end of upper member 54. In this way the upper member 52 and lower member 54 engage one another in frictional locked engagement.

Said another way, in this arrangement, upper member 52 connects to the interior diameter of lower member 54. Or, said yet another way, this is an interior diameter connection arrangement.

In this arrangement, when using a pod 33, 34, 35, in one arrangement the material of lip 46 is captured between these engaging features of upper member 52 and a lower member 54. In this way, the upper member 52 and a lower member 54 hold the pod 33, 34, 35 in place during use.

While this arrangement is effective, when pressing the upper member 52 into the lower member 54 this can cause some variation in the position of the upper member 36 of pod 33, 34, 35 which can cause a lack of penetration of the injection needle of brewing machine 12. In an alternative arrangement, upper member 52 includes a lip that extends over and around the outer diameter of lower member 54. Said another way, in this arrangement, upper member 52 connects to the exterior diameter of lower member 54. Or, said yet another way, this is an exterior diameter connection arrangement.

This exterior diameter connection arrangement has a tendency of providing increased repeatability and accuracy of placement of the upper member 36 of pod 34 within holder 50. In this arrangement, the lip 46 of pod 33, 34, 35 is placed on the upper edge of lower member 54 and the upper member 52 is placed over the lip 46 and the upper end of lower member 54. In this way, lip 46 of pod 33, 34, 35 is captured and held in place between the upper member 52 and a lower member 54 of holder 50. When the upper member 52 snaps onto or frictionally engages the upper end of lower member 54, this has a tendency of imparting a tension across the upper member 36 of pod 33, 34, 36 thereby pulling the upper member 36 tight. This has a tendency of locating the upper member 36 of pod 33, 34, 35 in an accurate and repeatable position just at the top of the lower member 54 of holder 50. This facilitates repeatable and highly accurate penetration of the upper needle of brewing machine 12 through upper member 36 of pod 33, 34 35.

Any other configuration, manner, method or means of connecting upper member 52 to lower member 54 is hereby contemplated for use.

It will be appreciated by those skilled in the art that other various modifications could be made to the device, method, and/or transporting system without parting from the spirit and scope of this disclosure. All such modifications and changes fall within the scope of the claims and are intended to be covered thereby.

What is claimed:

1. A biodegradable beverage pod system, comprising:
a pod;
the pod having a upper member;
the pod having a lower member;
a brewing medium;
wherein the top member and bottom member overlap one another at a lip;
wherein the top member and the bottom member are sealed to one another along the lip;
wherein the top member and the bottom member are formed of a biodegradable filter material;
wherein the connection of the top member to the bottom member form a hollow interior;
wherein the brewing medium is held within the hollow interior.

2. The system of claim 1, wherein the seal is formed by welding, adhering, folding, crimping, sewing or any combination thereof.

3. The system of claim 1, wherein the top member is generally planar in shape.

4. The system of claim 1, wherein the top member is generally circular in shape when viewed from above or below.

5. The system of claim 1, wherein the lip terminates at a generally circular periphery.

6. The system of claim 1, wherein the bottom member includes a bottom wall and a side wall.

7. The system of claim 1, wherein the bottom member includes a bottom wall and a side wall, wherein the sidewall is generally cylindrical in shape.

8. The system of claim 1, wherein the lip extends outward from an upper end of the bottom member in a generally perpendicular manner.

9. The system of claim 1, wherein the top member is generally planar in shape, wherein the bottom member includes a bottom wall and a sidewall, wherein the bottom wall is generally planar in shape, wherein the plane of the top member and the plane of the bottom wall extend in approximate parallel spaced relationship to one another, and wherein the sidewall of the bottom member extends in a cylindrical shape between the bottom wall and the top member.

10. The system of claim 1, wherein the bottom member is generally semi-spherical in shape.

11. The system of claim 1, wherein the bottom member connects at a top edge to the top member and extends away from the top member forming a semi-spherical in shape.

12. The system of claim 1, wherein the brewing medium consists of coffee, tea, hot cocoa mix or apple cider mix.

13. The system of claim 1, wherein the pod is configured to be held in a holder having a top member and a bottom member such that the lip of the pod is held between the top member and bottom member of the holder thereby holding the top member of the pod in a generally fixed position within the holder between the top member and the bottom member of the holder.

14. A method of brewing a beverage, the steps comprising:
providing a pod; the pod having a upper member and a lower member, wherein the top member and bottom member overlap one another at a lip, wherein the top member and bottom member are sealed to one another at the lip, wherein the top member and bottom member form a hollow interior; wherein the hollow interior holds brewing medium therein, wherein the top member and bottom member are formed of a biodegradable filter material;
placing the pod within a holder having a upper member and a lower member;
engaging the lip of the pod between the top member and bottom member of the holder thereby holding the top member of the pod in a generally fixed position within the holder between the top member and the bottom member of the holder;
placing the holder having the pod therein in a brewing machine;
passing fluid through the needle and through the pod thereby brewing a beverage.

15. The method of claim 14, further comprising the step of puncturing the top member of the pod with a needle of brewing machine.

16. The method of claim 14, wherein the seal is formed by welding, adhering, folding, crimping, sewing or any combination thereof.

17. The method of claim 14, wherein the top member is generally planar in shape.

18. The method of claim 14, wherein the top member is generally circular in shape when viewed from above or below.

19. The method of claim 14, wherein the lip terminates at a generally circular periphery.

20. A low-waste system for transporting a plurality of pods, the system, comprising:
a bag;
the bag having a sidewall;
the bag having a sealing member;
wherein the bag forms a hollow interior;
wherein the sealing member facilitates opening, closing and resealing of the hollow interior;
a plurality of pods;
the plurality of pods having a upper member;
the plurality of pods having a lower member;
the plurality of pods having a brewing medium;
wherein the top member and bottom member of the plurality of pods overlap one another at a lip;
wherein the top member and the bottom member of the plurality of pods are sealed to one another along the lip;
wherein the top member and the bottom member of the plurality of pods are formed of a biodegradable filter material;
wherein the connection of the top member to the bottom member form a hollow interior;
wherein the brewing medium is held within the hollow interior
wherein the plurality of pods are stored and shipped within the bag thereby reducing waste.
